(19) United States
(12) Patent Application Publication
(10) Pub. No.: US 2026/0257261 A1
(43) Pub. Date: Sep. 3, 2026

(54) BIOMIMETIC MULTIFUNCTIONAL LIGNOCELLULOSIC DEGRADABLE SORBENT FOR ENVIRONMENTAL REMEDIATION

(71) Applicant: THE TEXAS A&M UNIVERSITY SYSTEM, COLLEGE STATION, TX (US)

(72) Inventors: YUAN DAI, COLLEGE STATION, TX (US); JINGHAO LI, COLLEGE STATION, TX (US)

(21) Appl. No.: 18/875,220

(22) PCT Filed: Jun. 15, 2023
(86) PCT No.: PCT/US2023/025351

§ 371 Date: Dec. 16, 2024

Related U.S. Application Data
(60) Provisional application No. 63/352,766, filed on Jun. 16, 2022.

(51) Int. Cl. B09C 1/10; C02F 1/28; C02F 3/34; C02F 101/36; G01N 1/34; G01N 1/40

(52) U.S. Cl. CPC B09C 1/105; C02F 1/286; C02F 3/347; C02F 3/348; G01N 1/34; G01N 1/4077; B09C 2101/00; C02F 2101/36; G01N 2001/4088

(57) ABSTRACT

The subject invention pertains to an in-situ bioremediation system that employs a plant-derived biomimetic nano-framework to achieve highly efficient adsorption and subsequent microbial biotransformation of contaminants synergistically. The multiple component framework is presented as Renewable Artificial Plant for In-situ Microbial Environmental Remediation (RAPIMER). RAPIMER exhibits record adsorption capacity for contaminants, such as PFAS compounds, and diverse adsorption capability for other co-contaminants. Subsequently, RAPIMER provides the substrate for in situ bioremediation via microorganisms, such as Irpex lacteus, and can promote PFAS detoxification. RAPIMER arises from cheap lignocellulosic sources, enabling a broader impact on sustainability and a new means for low-cost pollutant remediation.

### CROSS-REFERENCE TO RELATED APPLICATION

This application claims the benefit of U.S. Provisional Application Ser. No. 63/352,766, filed Jun. 16, 2022, the disclosure of which is hereby incorporated by reference in its entirety, including all figures, tables and amino acid or nucleic acid sequences.

### STATEMENT REGARDING FEDERALLY SPONSORED RESEARCH

This invention was made with government support under R01ES032708 awarded by National Institute of Environmental Health Sciences. The government has certain rights in the invention.

### BACKGROUND OF THE INVENTION

Pollution from persistent organic chemicals (POPs) seriously threatens human and ecosystem health¹. Environmental remediation of POPs presents a global challenge^{2,3} and often involves expensive, complicated multi-step processes⁴. To date, remediation approaches often involve a treatment train encompassing pollutant adsorption⁵, detoxification, and subsequent material degradation⁶. However, existing practices are labor-intensive, costly, disjointed, and generate secondary pollution⁷. Thus, it is critical to develop synergized strategies that are well-integrated, cost efficient, environmentally benign, sustainable, and effective^{8,9}.

Efficient and integrated remediation solutions are needed for remediating common and widespread POP forms, such as perfluoroalkyl and polyfluoroalkyl substances (PFAS)¹⁰. PFAS are highly recalcitrant to degradation, cause severe damage to human and wildlife health, and are pervasive, being detected in remote areas that include the Arctic ocean¹¹. In humans, PFAS have been found to increase cancer, birth defects, and incidence of compromised immune systems¹²⁻¹⁴. There are over 9000 alternative PFAS molecules. The U.S. EPA has recognized the risk of PFAS molecules in the environment and is developing drinking water regulations related to two PFAS forms: perfluorooctanoic acid (PFOA) and perfluorooctanesulfonic acid (PFOS)¹⁵. Currently, the only commercial PFAS remediation method involves costly and unsustainable thermal deconstruction¹⁶. Even though many sorbents have been explored for environmental remediation¹⁷⁻²¹, their use is hindered by the need for costly metals or polymer-based materials and the creation of secondary pollution^{7,22}. While more sustainable and lower-cost chitosan, biochar, microbial biomass, and agricultural waste-based biosorbents have been studied, they lack the performance required for industrial applications²³. Bioremediation has been explored for PFAS remediation but is limited by low efficiency, slow processing times, and inability to remove trace level contaminants^{24,25}. Therefore, it is thus critical to address the challenges in sorbent, bioremediation, and treatment train integration with innovative, sustainable, efficient, integrative, and cost-effective solutions.

### BRIEF SUMMARY OF THE INVENTION

The subject invention provides a plant-based substrate and microbe-based products, as well as their use, to remediate contaminated sites by, for example, efficiently removing contaminants, such as persistent organic pollutants (POPs) (e.g., perfluoroalkyl and polyfluoroalkyl substances (PFAS)). In certain embodiments, the subject invention provides a plant-based substrate for the growth of microorganisms and adsorption of pollutants. The framework can comprise natural biopolymers, including, for example, lignin and cellulose and can stimulate the expression of various enzymes synthesized by the microorganisms that can enable degradation of the pollutants, including, for example, redox enzymes.

In a specific embodiment, the subject invention provides efficient methods for PFAS removal by utilizing the disclosed plant-based substrate, optionally colonized by one or more microbe. In further embodiments, the materials and methods can be used for bioremediation of contaminated waters, soils, and other sites.

In some embodiments, the method utilizes bacterial strains, fungal strains, yeast strains and/or by-products of their growth. In one embodiment, the microbe used in the methods of the subject invention is a fungus. The invention provides, for example, a microbe-based product comprising cultivated white rot fungus and/or products of the growth of that microbe. In addition, the invention provides a microbe-based product comprising cultivated bacterial or yeast strains such as, for example, Pseudomonas spp., Acidimicrobium spp., Gordonia spp. and/or its growth byproducts.

### BRIEF DESCRIPTION OF THE DRAWINGS

The patent or application file contains at least one drawing executed in color. Copies of this patent or patent application publication, with color drawing(s), will be provided by the Office upon request and payment of the necessary fee.

FIG. 1. The design strategy, fabrication process, chemical adsorption, and fungus degradation scheme of the RAPIMER system. Step i) Corn stover residual lignin solution and selective graft reaction using formaldehyde and polyethylenimine to produce positively charged modified lignin particles. Step ii) Corn stover derived cellulose nanofibrils prepared by TEMPO-oxidation method and modified lignin chemical structure. Step iii) The modified lignin and nanocellulose nanofibrils formed RAPIMER composite through self-assembly by the formation of carboxylic acid/amine interaction. Step iv) PFAS adsorption by the RAPIMER composite. Step v) Fungal bioremediation through co-metabolism and biodegradation of PFAS and RAPIMER system.

FIGS. 2A-2L. The characterization of the bioinspired composite materials and their components. FIG. 2A, The AFM image of cellulose fibers. FIG. 2B, The AFM image of cellulose nanofibrils. FIG. 2C, The average diameter estimate of cellulose fibers. FIG. 2D, The average diameter estimate of cellulose nanofibrils. FIG. 2E, The SEM image of cellulose fibers. FIG. 2F, SEM image of cellulose fiber/lignin composite. FIG. 2G, The SEM image of cellulose fiber/modified lignin composite. FIG. 211, SEM image of cellulose nanofibrils. FIG. 2I, The SEM image of cellulose nanofibril/lignin composite. FIG. 2J, The SEM image of RAPIMER composite. FIG. 2K, The FTIR spectra of lignin, polyethylenimine, modified lignin, and modified lignin after PFAS adsorption. The top light blue line: lignin, the second top dark lune line: polyethylenimine, the third green line: modified lignin, the fourth yellow-green line: PFOA adsorbed modified lignin, the bottom purple line: PFOS adsorbed modified lignin. FIG. 2L, The XPS spectra of different lignin, modified lignin, and modified lignin after PFAS adsorption. The top green line: PFOA adsorbed modified lignin. The second blue line: PFOS adsorbed modified lignin. The third red line: modified lignin. The bottom black line: lignin.

FIGS. 3A-3F. The characterization of material/PFAS adsorption. FIG. 3A, The PFOA adsorption kinetics of the bioinspired composite and their components. FIG. 3B, The PFOS adsorption kinetics of the bioinspired composite and their components. Blue diamond and curve: modified lignin, yellow-green triangle and curve: RAPIMER, orange triangle and curve: cellulose fiber/modified lignin composite, green triangle: cellulose nanofibrils, purple triangle: cellulose nanofibril/lignin composite, green square: cellulose fibers. Each time points are triplicate measurements. Due to the small variations, some replicates are overlapped and all points are shown in the figures (The invisible standard derivations are not applied in the figure due to the small variations). FIG. 3C, pH dependence of the modified lignin and RAPIMER composite adsorption capacity. Red open circle, RAPIMER composite; black open square, modified lignin. FIG. 3D, pH of zero charge of the modified lignin and RAPIMER composite. Red solid circle, RAPIMER composite; black solid square, modified lignin. FIG. 3E, Adsorption efficiency of the RAPIMER composites for PFOA and PFOS at 1 and 10 μg/L. The peristaltic pump filtration system was employed for this PFAS adsorption measurements (FIG. 14). FIG. 3F, Adsorption efficiency of the RAPIMER composites for 1 mg/L PFOS, PFOA, anionic dye, chromium (Cr), cadmium (Cd), copper (Cu), lead (Pb) mixtures in the rain water. The peristaltic pump filtration system was employed for this PFAS adsorption measurements (FIG. 14).

FIGS. 4A-4G. The isothermal models and absorption mechanism. FIG. 4A, The adsorption isotherms of the modified lignin and RAPIMER composite binding with PFOA. FIG. 4B, The adsorption isotherms of the modified lignin and RAPIMER composite binding with PFOS. The solid red line: Langmuir fitting model. The dotted blue line: Freundlich fitting model. Top fitting: modified lignin. Bottom fitting: RAPIMER. Each concentration had triplicate measurements and all overlapped points were shown in the figures (the invisible standard derivations are not applied in the figure due to the small variations). FIG. 4C, The SEM image of PFOA adsorbed RAPIMER composite. FIG. 4D, The EDX image of PFOA adsorbed RAPIMER composite with color coding for different elements. Red: carbon, green: oxygen (28.0 wt %), blue: nitrogen (1.4 wt %), purple: fluorine (21.4 wt %). FIG. 4E, The SEM image of PFOS adsorbed RAPIMER composite. FIG. 4F, The EDX image of PFOS adsorbed RAPIMER composite with color coding for different elements. Red: carbon (51.0 wt %), green: oxygen (27.2 wt %), blue: nitrogen (1.1 wt %), purple: fluorine (19.0 wt %), yellow: sulfur (1.7 wt %). FIG. 4G, The SEM and EDX images of PFAS/dye/metals contaminants as-adsorbed RAPIMER composite with color coding for different elements. purple: fluorine, yellow: sulfur, blue violet: chromium, light green: cadmium, emerald green: lead, orange: copper, green: sodium, and blue green: chlorine. The results were based on three repeated measurements and all replicates are shown in the figures.

FIGS. 5A-5F. The assessment of fungal degradation of RAPIMER integrated system. FIG. 5A, The fungal growth curve on different bioinspired composites. Top green line: RAPIMER composite, blue line: cellulose nanofibril/lignin composite, red line: cellulose nanofibril, black line: glucose deprived Kirk media as the control. FIG. 5B, The fungal growth curve on RAPIMER composite treated with solutions in different PFAS concentrations. The blue line: 100 μg/L. The purple line: 1000 μg/L. The green line: 10,000 μg/L. The red line: 10 μg/L. The black line: Kirk media as the control. All PFAS solution is the mixture of PFOA/PFOS (1:1). FIG. 5C, The microscope images of fungal growth on different materials. (1) Glucose-derived Kirk media, (2) RAPIMER composite, (3) Cellulose nanofibril composite, (4) cellulose nanofibril/lignin composite. The background is adjusted into black to show the fungus mycelia. FIG. 5D, The digital microscopy image of I. lacteus hyphae growing on the RAPIMER substrate adsorbed with PFAS. FIG. 5E, The RAPIMER induced overexpressed enzymes upon PFAS treatment. The numbers denoted the normalized spectra counts for the proteins in the heat map. FIG. 5F, The GO enriched pathway analysis of upregulated proteins in the PFAS treatment conditions.

FIGS. 6A-6H. The environmental impacts of the activated carbon (AC), exchanged resin (ER) and RAPIMER on acidification (FIG. 6A), climate change (FIG. 6B), ecotoxicity (CTUe is the comparative toxicity unit for ecotoxicity) (FIG. 6C), human toxicity (cancer) (CTUh is the comparative toxicity unit for human health) (FIG. 6D), human toxicity (non-cancer) (CTUh) (FIG. 6E), ozone depletion (CFC-11 (trichlorofluoromethane) equivalent) (FIG. 6F), particulate matter (FIG. 6G), and surface ozone formation (FIG. 6H) for 1 m³ groundwater treatment (non-methane volatile organic compound (NMVOC)).

FIG. 7. The concept and mechanism of the RAPIMER system for PFAS removal and biodegradation. Both constituent materials, cellulose and lignin, were produced from corn stover residue and then engineered to develop the RAPIMER composite. The PFAS enriched RAPIMER composite worked like plant cell wall as the sole carbon source to sustain fungus growth and was synergistically biodegraded.

FIG. 8. The SEM images of cellulose fibers and cellulose nanofibrils. The morphologies of cellulose fibers and cellulose nanofibrils showed the fiber dimeters of cellulose nanofibrils were significantly reduced from cellulose fibers after TEMPO-oxidation process. The experiment was reproduced 3 times.

FIG. 9. Hydrostability of different material composites. The RAPIMER and cellulose fiber/modified lignin composites were immersed in the DI water. The RAPIMER composites were immersed in the DI water after 24 hours. The RAPIMER composite maintained its structure while the cellulose fiber/modified lignin composite separated in the water after 24 hours.

FIGS. 10A-10D. EDX images of lignin and modified lignin. FIGS. 10A-10B show the morphologies of lignin and modified lignin with element analysis, respectively. The result demonstrated that the content of nitrogen element significantly increased in modified lignin compared with lignin, which indicated the polyethylenimine was successfully grafted on lignin. FIGS. 10C-10D show the morphologies of modified lignin with element analysis after adsorbing PFOA and PFOS, respectively. The results indicated that both PFOA and PFOS were adsorbed by the modified lignin, in which the fluoride and sulfur elements were detected by EDX.

FIGS. 11A-11F. The details of XPS image (FIG. 2L) in carbon peak and nitrogen peak of lignin and modified lignin before and after PFAS adsorption. FIGS. 11A-11B are carbon peaks for lignin and modified lignin, respectively. The lignin and modified lignin spectra indicated the presence of four types of carbon atoms in different functional groups: The hydrocarbon (C═C/C—C 284.5 eV), noncarbonylic carbon (C—O, 285.8 eV), carbonyl carbon (C═O 286.7 eV), and carboxylate carbon (O═C—O 288.6 eV). The peak intensity and ratio of C═C/C—C carbon in the modified lignin significantly increased compared to that of lignin, which indicated that the polyethylenimine with C═C/C—C carbon was effectively grafted on the lignin during the chemical reaction. FIGS. 11C-11D are carbon peaks for modified lignin after adsorbing PFOA and PFOS. Compared to the spectra of lignin and modified lignin (FIGS. 11A-11B), the high-resolution XPS C1s spectra of the modified lignin after adsorbing PFOA and PFOS showed three more peaks representing (C—F 288.5 eV), (—CF₂ 291.7 eV), and (—CF₃ 294.0 eV), respectively. It indicated that the PFOA and PFOS have been adsorbed and immobilized on the surface of the modified lignin. FIGS. 11E-11F are the nitrogen peaks of lignin and modified lignin. The high-resolution XPS N1s spectra of the lignin and modified lignin showed the intensity significantly increased in modified lignin compared with that of lignin. The three peaks could be fitted at 398.1 eV, 398.7 eV, and 399.3 eV, which could be considered as secondary amino, primary amino, and tertiary amino, respectively. This indicated that the amino groups on polyethylenimine had grafted onto the lignin as a cationic ion in the RAPIMER systems.

FIG. 12. FTIR spectra of cellulose nanofibril, cellulose nanofibril/lignin composite, and the RAPIMER composite. The peak of free carboxyl groups (1720 cm⁻¹ in both blue cellulose nanofibril composite and cellulose nanofibril/lignin composite spectra) was entirely shifted to that of carboxylate groups (1600 cm⁻¹ in the purple RAPIMER spectrum) by the formation of carboxylic acid/amine salt.

FIG. 13. TGA analysis of the RAPIMER composite. Black solid line, percentage weight loss of the RAPIMER composite. Blue solid line, derivative weight of the composite material. The RAPIMER composite thermal degradation started around 200° C.

FIG. 14. Customized filter packed with RAPIMER composite for 1 μg/L and 10 μg/L PFOA and PFOS adsorption testing.

FIGS. 15A-15H. The life cycle impact assessment results per kg of the activated carbon (AC), exchanged resin (ER) and RAPIMER on acidification (FIG. 15A), climate change (FIG. 15B), ecotoxicity (CTUe) (FIG. 15C), human toxicity (cancer) (CTUh) (FIG. 15D), human toxicity (non-cancer) (CTUh) (FIG. 15E), ozone depletion (CFC-11 (trichlorofluoromethane) equivalent) (FIG. 15F), particulate matter (FIG. 15G), and surface ozone formation (non-methane volatile organic compound (NMVOC)) (FIG. 15H).

### DETAILED DISCLOSURE OF THE INVENTION

As used herein, each of the following terms have the meanings associated with it as specified below. Unless defined otherwise, all technical and scientific terms used herein generally have the same meaning as commonly understood by one of ordinary skill in the art to which this invention belongs.

As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising”. The transitional terms/phrases (and any grammatical variations thereof) “comprising”, “comprises”, “comprise”, “consisting essentially of”, “consists essentially of”, “consisting” and “consists” can be used interchangeably.

The term “about” or “approximately” means within an acceptable error range for the particular value as determined by one of ordinary skill in the art, which will depend in part on how the value is measured or determined, i.e., the limitations of the measurement system. For example, “about” can mean within 1 or more than 1 standard deviation, per the practice in the art. In the context of reagent and/or analyte concentrations, the term “about” can mean a range of up to 0-20%, 0 to 10%, 0 to 5%, or up to 1% of a given value. Thus, in the context of compositions containing amounts of ingredients where the terms “about” or “approximately” are used, these compositions contain the stated amount of the ingredient with a variation (error range) of 0-10% around the value (X±10%), of 0-5% around the value (X±5%), or up to 1% around the value (X±1%). In the context of pH measurements, the terms “about” or “approximately” permit a variation of ±0.1 unit from a stated value.

In the present disclosure, ranges are stated in shorthand, so as to avoid having to set out at length and describe each and every value within the range. Any appropriate value within the range can be selected, where appropriate, as the upper value, lower value, or the terminus of the range. For example, a range of 0.1-1.0 represents the terminal values of 0.1 and 1.0, as well as the intermediate values of 0.2, 0.3, 0.4, 0.5, 0.6, 0.7, 0.8, 0.9, and all intermediate ranges encompassed within 0.1-1.0, such as 0.2-0.5, 0.2-0.8, 0.7-1.0, etc. Values having at least two significant digits within a range are envisioned, for example, a range of 5-10 indicates all the values between 5.0 and 10.0 as well as between 5.00 and 10.00 including the terminal values.

As used herein, the term “cellulosic biomass” refers to any biomass material, preferably vegetal biomass, comprising cellulose, hemicellulose and/or lignocellulose, preferably comprising lignocellulose. Cellulosic biomass includes, but is not limited to, plant material such as forestry products, woody feedstock (softwoods and hardwoods), agricultural wastes and plant residues (such as corn stover, sorghum, sugarcane bagasse, grasses, rice straw, wheat straw, empty fruit bunch from oil palm and date palm, agave bagasse), perennial grasses (switchgrass, miscanthus, canary grass, erianthus, napier grass, giant reed, and alfalfa); plant-based municipal solid waste (MSW), aquatic products such as algae and seaweed, wastepaper, cotton, hemp, natural rubber products, and food processing by-products.

In certain embodiments, contaminants that can be removed by the disclosed RAPIMERS include, and are not limited to, perfluoroalkyl or polyfluoroalkyl substances (PFASs). In particular embodiments, the perfluoroalkyl or polyfluoroalkyl substance includes one or more of: perfluorooctane sulfonate (PFOS); perfluorooctanoic acid (PFOA); perfluorohexane sulfonate (PFHxS); poly fluorinated carboxylic acids, alkyl sulfonates; alkyl sulfonamido compounds; and fluorotelemeric compounds. Other contaminants that can be removed by the disclosed RAPIMERS include, and are not limited to, copper (Cu), cadmium (Cd), chromium (Cr), anionic dyes, and lead (Pb).

The terms “fluid” or “liquid medium” are used herein to refer to a substance which is in the form of a liquid at ambient temperature or room temperature.

The phrase “passing contaminated fluid through . . . ” is used herein to refer to a process whereby the contaminated fluid from a particular source, such as wastewater or contaminated water, is brought into contact with a RAPIMER substrate as described herein. Pressure and/or stirring is applied to force the contaminated fluid through the RAPIMER substrate. The pressure may be a positive pressure, which is provided by, for example, a positive displacement pump that is located upstream of and fluidly connected to a filter apparatus containing the RAPIMER substrate. Alternatively, the pressure may be a negative pressure, which is provided by, for example, a vacuum pump that is located downstream of and fluidly connected to the outlet of the filter apparatus. Each of the positive or negative pressure may be in a range of about 1 to about 10 bars, about 2 to about 8 bars, or about 4 bars.

The term “adsorbent” refers to a substance which has the ability to condense or hold molecules or other substances on its surface or in its inner structure, an activity often referred as “adsorbing” or “absorbing”. As disclosed herein, the RAPIMER surface has the ability to adsorb various contaminants, such as lead, chromium, cadmium, and PFAS compounds.

The term “RAPIMER” refers to a “renewable artificial plant for in-situ microbial environmental remediation”. The RAPIMER can, in some embodiments, be colonized with microbes on the surface of the RAPIMER. Other embodiments contemplate RAPIMERs that are not colonized by microbes (also referred to as an “uncolonized RAPIMER”). As discussed herein, the RAPIMER can be colonized with microbes on the surface of the RAPIMER. Other embodiments contemplate RAPIMERs that are not colonized by microbes (also referred to as an “uncolonized RAPIMER”). The phrase “on the surface” means that microbes have been deposited on the surface of the lignin and the cellulose nanofibrils that make up the RAPIMER and grow on the surface of the RAPIMER.

The terms “microbe” and “microorganism” are used herein to refer to an organism that is too small to be visible with the naked eye. A microorganism can be formed by a single cell or by a small number of cells. Non-limiting examples of microorganisms include: bacteria, (Archaea, Eubacteria), yeast, and fungi. For the purposes of this disclosure, the term microbe shall be understood to include those bacteria, (Archaea, Eubacteria), yeast, and fungi capable of metabolizing contaminants found within a contaminated sample, for example a contaminated fluid, such as water. The different types of microorganisms suitable for bioremediation of contaminated fluids are known to those skilled in the art and to the literature and include one or more bacteria to biodegrade carbonaceous compounds such as various Pseudomonas species (such as Pseudomonas vesicularis, Pseudomonas putida and Aeromonashydrophila, Brevibacteriumacetylicum, bacteria to biodegrade nitrogen-containing compounds such as Nitrobacter species such as Nitrobacter winogradskyi and Nitrosomonas species such as Nitrosomonas europaea and bacteria to biodegrade sulfur-containing compounds such as Thiobacillus species such as Thiobacillus denitrificans and the like. Various fungi can also be utilized such as mushrooms, molds, mildews, smuts, rusts, and yeasts, and any combination thereof. In particular embodiments, a fungus, such as Irpex lacteus are used to colonize a RAPIMER.

In certain embodiments, the fungus is a white rot fungus, brown rot fungus, or soft rot fungus. In certain embodiments. The white rot fungus or brown rot fungus includes, for example, Acanthophysium spp., Agrocybe spp. (e.g., A. praecox), Aleurocystidiellum spp., Aleurodiscus spp., Armillaria spp. (e.g., A. cepistipes, A. gallica, A. mellea, A. nabsona, and A. sinapin), Athelia spp. (e.g., A. decipiens), Basidioradulum spp., Botryobasidium spp. (e.g., B. Botryosum and B. Subcoronatum), Butlerelfia spp., Christiansenia spp., Crepidotus spp., Corticium spp. (e.g., C. appalachiensis), Cystostereum spp., Cytidia spp., Dacrymyces spp., Dendrophora spp., Dentocorticium spp., Dichomitus spp. (e.g., D. squalens), Duportella spp., Entomocorticium spp., Hyphoderma spp. (e.g., H. setigerum), Hyphodontia spp., Hypochnicium spp. (e.g., H. bombycinum), Hypsizygus spp. (e.g., H. ulmarius), Peniophora spp., Phanerochaete spp. (e.g., P. affinis, P. arizonica, P. burtii, P. carnosa, P. chrysosporium, P. ericina, P. laevis, P. magnoliae, P. sanguinea, P. sordida), Phlebia spp. (e.g., P. ludoviciana, P. radiata), Phlebiopsis spp. (e.g., P. gigantea), Platygloea spp., Pleurotus spp. (e.g., P. ostreatus), Polyporus spp. (e.g., P. squamosus), Porodaedalea spp. (e.g., P. pini), Pulcherricium spp., Resinicium spp. (e.g., R. bicolor), Vuilleminia spp., mitosporic Corticiaceae spp. (including Fibularhizoctonia Fibularhizoctonia), Anomoporia spp., Antrodia spp. (e.g., A. heteromorpha, A. radiculos), Antrodiella spp., Aurantiporus spp., Auriporia spp., Bjerkandera spp. (e.g., B. adusta), Ceriporia spp. (e.g., C. reticulata), Ceriporiopsis spp. (e.g., C. subvermispora), Cerrena spp. (e.g., C. unicolor), Climacodon spp. (e.g., C. septentrionalis), Coniochaeta spp. (e.g., C. ligniaria), Coriolopsis spp. (e.g., C. gallica), Coriolus spp., Cryptoporus spp., Daedalea spp., Daedaleopsis spp., Datronia spp., Diplomitoporus spp. (e.g., D. overholtsii), Donkioporia spp., Echinodontium spp. (e.g., E. tinctorium), Entoloma spp., Exidia spp. (e.g., E. glandulos), Fibroporia spp. (F. radiculosa), Fomes spp. (e.g., F. fomentarius), Fomitopsis spp. (e.g., F. pinicola), Fulvifomes spp. (e.g., F. robiniae), Fuscoporia spp., Ganoderma spp. (e.g., G. lucidum), Gelatoporia spp., Hapalopilus spp., Inonotus spp. (e.g., I. andersonii), Jaapia spp. (e.g., J. argillacea), Kneiffiella spp. (e.g., K. alutacea), Lentinula spp. (e.g., L. edodes), Lentinus spp. (e.g., L. tigrinus), Laetiporus spp., Leptoporus spp., Megasporoporia spp., Melanoporia spp., Meripilus spp., Nigroporus spp., Nothopanus spp., Oligoporus spp., Ossicaulis spp., Oxyporus spp. (e.g., O. populinus), Perenniporia spp., Peniophorella spp. (e.g., P. pubera), Piptoporus spp., Phellinus spp. (e.g., P. igniarius, P. robiniae), Poria spp., Postia spp. (e.g., P. placenta), Ramaria spp., Rigidoporus spp., Schizophyllum spp. (e.g., S. commune), Schizopora spp. (S. paradoxa), Serpula spp. (e.g., S. himantioides), Sistotrema spp. (e.g., S. brinkmannii), Steccherinum spp. (e.g., S. tenue), Stereum spp. (e.g., S. ostrea), Tapinella spp. (e.g., T. panuoides), Tinctoporellus spp., Tomentella spp., Trametes spp. (e.g., T. conchifer, T. cubensis, T. elegans, T. hirsuta, T. pubescens, T. suaveolens, T. versicolor, T. villosa), Trichaptum spp., Tyriomyces spp., Wolfiporia spp. (e.g., W. cocos, W. extensa), Byssomerulius spp., Efibula spp., Emmia spp., Flavodon spp., Gloeophyllum spp. (e.g., G. sepiarium), Gloeoporus spp. (e.g., G. dichrous), Hydnochaete spp. (e.g., H. olivacea, H. Cinnamomea), Hydnopolyporus spp., Irpex spp. (e.g., I. lacteus), Leptoporus spp., Meruliopsis spp., and Trametopsis spp. (e.g., T. cervina), Trechispora spp. (e.g., T. farinacea), Tremella spp., Xylodon spp. (e.g., X. sambuci) Agaricus spp., Laetiporus spp. (e.g., L. cincinnatus, L. sulphureus), and Sparassis spp. In a particular embodiments, the fungus is Irpex lacteus.

The terms “reduces”, “reducing”, “reduce” or “reduced” mean, in the context of this disclosure a negative alteration of at least 1%, 5%, 10%, 25%, 50%, 75%, or 100% of a contaminant found within a sample.

The microorganisms (also referred to as microbes) grown according to the systems and methods of the subject invention can be, for example, bacteria, yeast and/or fungi. These microorganisms may be natural, or genetically modified microorganisms. For example, the microorganisms may be transformed with specific genes to exhibit specific characteristics.

The present disclosure relates to a plant-based substrate referred to herein as a RAPIMER or as RAPIMERs. The disclosure also relates to purification filters (also referred to as a “filter apparatus”) comprising RAPIMERs and methods of purifying contaminated fluids using RAPIMERS and/or filters comprising said RAPIMERs.

A RAPIMER is a renewable artificial plant for in-situ microbial environmental remediation that comprises lignin and cellulose nanofibrils. In certain preferred embodiments, the lignin is chemically modified with polyethylenimine and the carboxylic acid groups of the cellulose nanofibrils and amine groups found on the polyethylenimine modified lignin of the RAPIMER form a carboxylic acid/amine salt. The term “polyethylenimine” can include linear polyethylenimines, branched polyethylenimines and/or mixtures of linear polyethylenimines and branched polyethylenimines. The RAPIMER may, optionally, further comprise one or more microbe that degrades one or more contaminant (for example, copper, cadmium, chromium, lead or PFAS) found within a contaminated fluid. In various embodiments, the chemically modified lignin comprises a lignin modified with a branched polyethylenimine. Other embodiments contemplate the use of linear polyethylenimine to modify lignin. Yet other embodiments provide lignin that is modified with a combination of linear and branched polyethylenimine. In preferred embodiments, branched polyethylenimine is used to modify the lignin used to form a RAPIMER.

In various embodiments the RAPIMER is formed from dried lignin (optionally modified with polyethylenimine) and a cellulose nanofibril suspension at a ratio of about 1:5 to about 5:1 cellulose nanofibril: modified lignin w/w, about 1:4 to about 4:1 cellulose nanofibril: modified lignin w/w, about 1:3 to about 3:1 cellulose nanofibril: modified lignin w/w, about 1:2 to about 2:1 cellulose nanofibril: modified lignin w/w, about 1:1 cellulose nanofibril: modified lignin w/w, or about 0.5:1 to about 1:0.5 cellulose nanofibril: modified lignin w/w.

In various embodiments, the RAPIMER may exhibit one or more of the following characteristics of a Fourier Transform Infrared Spectroscopy (FTIR) spectra comprising the following characteristics: an amine peak at about 3380 cm⁻¹, C—H stretching and scissoring bands at 2940-2830 cm⁻¹ and 1463 cm⁻¹, and amide I and amide II with O═C stretch peaks around 1656 cm⁻¹ and 1599 cm⁻¹. In certain embodiments, the RAPIMER exhibits all of the characteristics discussed within this paragraph.

### Purification Filters/Filter Apparatus

The present invention also relates to a filter apparatus (purification filter) comprising the disclosed RAPIMERs. In one aspect, the filter comprises a housing that is non-permeable to a fluid, for example a tubular housing, a fluid sample inlet and a fluid sample outlet. In one embodiment, the tubular housing has a proximal end, a distal end, and lumen therethrough which contains a RAPIMER. In one embodiment, the fluid sample inlet and fluid sample outlet create a flow-path through the lumen of the filter apparatus that contains a RAPIMER for a contaminated fluid. Typically, the fluid sample inlet is downstream of a contaminated fluid source.

The tubular housing may comprise any material known in the art, including, but not limited to, organic polymers, inorganic polymers, homopolymers, copolymers, thermoplastics, thermosets, glass, quartz, ceramic, silica, alloy, metal alloy, stainless steel, stainless steel alloy, aluminum, aluminum alloy, aluminum oxide, copper, copper alloy, titanium, titanium alloy, brass, plastic, or any combination thereof. Exemplary plastics include, but are not limited to, polyolefins, polyethylene, high-modulus polyethylene (HMPE), polypropylene, polybutylene, polybutene, polybutadiene, polybutylene terephthalate (PBT), polyethylene terephthalate (PET), polytetrafluoroethylene (PTFE), polyvinylidene fluoride (PVDF), polycyclopentadiene (PCP), hydrogenated polycyclopentadiene (HCPC), polyetherimide (PEEK), polystyrene (PS), polyurethane (PU), polycarbonate (PC), polyacrylate, polymethacrylate, poly(methyl)methacrylate, polyoxymethylene, polylactic acid, polyether ether ketone, polyvinyl ether, polyvinyl chloride (PVC), chlorinated polyvinyl chloride, acrylonitrile butadiene styrene (ABS), polyethylene vinyl acetate (PEVA), styrene-butadiene copolymer, fluorinated polymer, and combinations thereof.

### Method of Fluid Purification

In one aspect, the present invention relates in part to a method of decontaminating a contaminated fluid or sample (for example, contaminated water). In this method, a contaminated fluid is contacted with a filter apparatus containing a RAPIMER. The RAPIMER can be colonized, uncolonized or a mixture of both colonized and uncolonized RAPIMERs. The contaminated fluid is passed through the fluid sample inlet into the lumen of the filter apparatus containing a RAPIMER. Contaminants are bound (adsorbed) to the RAPIMER and the fluid continues to pass through the filter apparatus and out of the filter apparatus via the fluid outlet where it is collected. The filter apparatus can be oriented in any directions, such as horizontally or vertically. In one embodiment, the step of passing the contaminated fluid through the filter apparatus comprises the step of passing the contaminated fluid through into the fluid inlet, through the lumen of the apparatus, and out via the outlet. As discussed above, contaminants are adsorbed to a RAPIMER provided within the lumen of the filter apparatus. The filter apparatus can, optionally, further comprise additional adsorbents, such as charcoal, activated carbon, powdered activated carbon (PAC), ion exchange resins, or combinations thereof.

In various embodiments, the fluid comprises a contaminant, such as copper, a PFAS, lead, chromium, cadmium. Thus, the contaminant may be any organic compound, inorganic compound, salt, or any combination thereof. In one aspect, the contaminated fluid is water is provided from a water source. The water source can be freshwater, salt water, or a combination thereof (e.g., brackish water). As would be apparent to those skilled in the art, the disclosed filter apparatus can be used with any water source known to a person of skill in the art.

In one embodiment, the filter apparatus can be configured to treat/purify water from a faucet or water fountain. In another embodiment, the filter apparatus can be used in a water storage container such as a pitcher or bottle and water added to a reservoir such that it flows through the filter apparatus. In one embodiment, a RAPIMER as disclosed herein can be submerged or added to a water source to adsorb contaminants found within the water source. In various of these embodiments, the RAPIMER can be colonized with microbes on the surface of the RAPIMER. Other embodiments contemplate RAPIMERs that are not colonized by microbes (also referred to as an “uncolonized RAPIMER”). Yet other embodiments provide a combination of both colonized RAPIMERs and uncolonized RAPIMERs.

### Use of RAPIMERs in Bioremediation

In another embodiment, the compositions and methods of the subject invention can be used for bioremediation of contaminated fluids (such as water), soils, surfaces, or other sites contaminated with various contaminants, such as PFAS compounds.

Embodiments of the present invention comprise both in situ and ex situ bioremediation methods of contaminated solids, soils, and waters (ground and surface) wherein in situ techniques are defined as those that are applied to, for example, soil and groundwater at the site with minimal disturbance. Ex situ techniques are those that are applied to, for example, soil and groundwater that have been removed from the site via, for example, excavation (soil) or pumping (water).

In situ techniques are generally the most desirable options due to lower cost and fewer disturbances to the environment.

Ex situ techniques typically involve the excavation or removal of contaminated soil or contaminated fluids from the ground or contaminated bodies of water.

In some embodiments, bioreactors, tanks or columns, including slurry reactors or aqueous reactors, can be used for ex situ treatment of contaminated soil or contaminated fluids (e.g., water) pumped from a contaminated site. In certain embodiments, the columns or tanks can be of various capacities, including, for example, at least about 1 mL, about 10 mL, about 100 mL, about 1 L, about 2 L, about 5 L, about 10 L, about 100 L, about 1000 L, about 10000 L, about 100000 L, or about 1000000 L. Bioremediation in reactors involves the processing of contaminated solid material (soil, sediment, sludge) or water through an engineered containment system. A slurry bioreactor may be defined as a containment vessel and apparatus that creates conditions that increase the bioremediation rate of soil-bound and water-soluble pollutants as a water slurry of the contaminated soil or fluid (e.g., water). Colonized RAPIMERs, uncolonized RAPIMERs or mixtures of colonized or uncolonized RAPIMERs are provided within the containment vessel and reduce the amount of contaminants found within the slurry. Bioremediation can also be performed within a tank or a column. In such embodiments, a fluid or slurry comprising a contaminant is contacted within the tank or column with colonized RAPIMERs, uncolonized RAPIMERs or mixtures of colonized and uncolonized RAPIMERs to reduce the amount of contaminants found within the contaminated fluid. The decontaminated fluid or slurry can be, then, recovered from the tank or the column.

### Materials and Methods

### Materials

Corn stover was obtained from a cornfield after harvest in College Station, TX. Sodium hydroxide (NaOH), ammonium acetate, ethylenediaminetetraacetic acid (EDTA), sodium dodecyl sulfate, magnesium chloride hexahydrate, 37% formaldehyde solution, polyethylenimine (PEI), citric acid, Bradford reagent, urea, thiourea, trizma base, 3-(4-Heptyl)phenyl-3-hydroxypropyl) dimethylammoniopropanesulfonate, direct red 81, 95% perfluorooctanoic acid (PFOA), and 98% purity perfluoro-1-octanesulfonic acid (PFOS) were purchased from Sigma Aldrich (St. Louis, MO). 1,4 Dithiothreitol was purchased from Roche Diagnostics (Indianapolis, IN). (2,2,6,6-Tetramethylpiperidin-1-yl) oxyl (TEMPO), sodium bromide (NaBr), and sodium hypochlorite (NaClO) were purchased from Fisher Scientific (Waltham, MA). The isotope-labeled PFOA (Perfluoro-n-[1,2-13C2]octanoic acid and sodium perfluoro-1-[1,2,3,4-13C₄]octanesulfonate were purchased from Wellington Laboratory (Guelph, Ontario). The metal solutions (lead, chromium, copper, and cadmium) were from SCP Science (Quebec, Canada).

### Lignin and Cellulose Separation

An alkaline process was used to separate lignin and cellulose fibers from corn stover. In particular, 100 g of dried corn stover was added to a 2 L flask with 1000 mL sodium hydroxide solution (1% w/v) and then heated by an Amsco LG 250 Laboratory Steam Sterilizer (Steris, USA) for 1.5 hours at 120° C. After cooling to room temperature, the cellulose fibers were separated by the grade 1 Whatman® filter paper and then washed with distilled water until the pH was neutral. The resultant cellulose fibers were stored in the 4° C. refrigerator for further treatment. The residual lignin solution was kept for lignin recovery.

### Cellulose Nanofibrils Preparation

The TEMPO-oxidization method was employed to prepare corn stover based cellulose nanofibrils. They were produced via alkaline lignocellulosic pulp processing in which 4 grams of cellulose fibers were dispersed in distilled water containing 0.06 g TEMPO and 0.4 g NaBr for 30 minutes, and then 20 mmol NaClO solution (13%, w/w) was added. In turn, pH was controlled at 10 using the addition of 0.5 M NaOH solution and given 1 hour to diffuse. The oxidized cellulose fibers were then filtered and washed with distilled water until the pH was neutral. After that, a high-pressure homogenizer was used to further process the fibers. The resultant 0.6% (w/w) cellulose nanofibrils suspension was then stored at 4° C. for further processing.

Lignin Recovery from the Residual Lignin Solution

In turn 500 mL of residual lignin solution was first dialyzed with a 1000 MW dialysis tube. After dialysis, a HCl solution (0.5 mol/L) was added to precipitate the lignin and was allowed to work until the pH reached 2. Then the resultant liquor was centrifuged at 6000 rpm for 5 min and filtered. This yielded about 5 g of precipitated lignin. That lignin was separated, washed with acidified water at pH 2. The result was then freeze vacuum dried for about 24 hours until a constant weight was observed. The final corn stover lignin samples were stored in a desiccator for further characterization or used.

### Composite Materials Preparation

To form the RAPIMER composite, citric acid (0.06 g) was added into a 250 mL beaker that contained 100 mL of the earlier prepared suspension with the cellulose nanofibrils (0.6 wt %), and this was mixed for 1 hour. Then, 0.6 g of modified lignin was added. The resulting mixture (that exhibited a cellulose fibril: modified lignin ratio of 1:1 w/w) was stirred for 1 hour before cooled at 4° C. overnight. The precooled aqueous gel was then frozen at −80° C. for 20 mins, and the resulting frozen samples were freeze-dried in a lyophilizer at a condenser temperature of −50.0° C. under vacuum (0.0004 mbar) for two days. After the freezing dry process, the RAPIMER composite was subsequently cured in a vacuum oven at 80° C. for 4 hours and stored in a desiccator for further use. The cooling to the curing processes were also applied to fabricate the cellulose fibers, cellulose nanofibrils, and cellulose fiber/lignin composite. The cellulose nanofibrils/modified lignin composition was tested at three different nanofibrils: modified lignin (w/w) ratios: 2:1, 1:1, and 1:2 to evaluate the composite biodegradability. The optimum ratio (1:1) was chosen to fabricate the RAPIMER composite.

### Contaminant Adsorption Experiments

PFAS solutions were prepared for adsorption and degradation tests in batch mode using 50 mL polypropylene bottles at the pH value of 7.0±0.1 (adjusted by sodium hydroxide). PFOA and PFOS solutions were prepared at various concentrations. The engineered materials were weighed, added into the PFAS solution, and then shaken in an orbital shaker at 150 rpm at room temperature. The PFAS adsorbed materials were then collected, freeze-dried, or autoclaved to prepare for further use. The HPLC-MS was used to detect the PFOA and PFOS concentrations; optical density (OD) measurements were used to measure the anionic dye concentration; and ICP-MS was used to detected Cu, Pb, Cr, and Cd concentrations of the influent and effluent in the online flow testing. The element composition, such as C, N, O, F, S, Na, Cl, Cu, Pb, Cr, and Cd, of the RAPIMER after the adsorption test was measured by energy dispersive spectroscopy (EDS) at an accelerating voltage of 15 kV. PFOA and PFOS solutions were prepared at various concentrations for different tests, the additional PFAS adsorption testing, PFAS quantitation, and PFAS-contaminated realistic water simulation test (details are described in Supplementary notes 1, 2, 3, 4, and 5).

The adsorption kinetic study was determined by an individual batch experiment using 50 mL polypropylene bottles at a pH value of 7.0±0.5. The 100 mg/L PFOA and PFOS solution were prepared for the adsorption kinetics test with 25 mg/L cellulose fiber, cellulose nanofibrils, modified lignin, cellulose fiber/lignin, cellulose fiber/modified lignin, cellulose nanofibrils/lignin, and RAPIMER composites, respectively. The mixtures were shaken in an orbit shaker at 150 rpm at room temperature (23±1° C.) before the adsorption test. After 20 mins stabilization, all samples were collected using 0.2 μm polypropylene syringe filter from supernatant at 0 h, 0.5 h, 1 h, 2 h, 4 h, 4 h, 8 h, 8 h, 16 h, 16 h, 32 h, and 32 h for the PFAS concentration test by High-Performance Liquid Chromatography Mass Spectrometry (HPLC-MS) assay, respectively. Experiments were performed in triplicates, due to the small variations, all points were reported instead of the standard deviation. For the adsorption kinetics model, the pseudo-first-order model (eq. 1) was used to fit the experimental results as follows:

$$\frac{t}{{q}_{t}} = \frac{1}{k {q}_{e}^{2}} + \frac{t}{{q}_{e}} \qquad ( 1 )$$

where qₜ (mg/g) is the quantity of PFOA and PFOS adsorbed at different contact time t, respectively. qₑ (mg/g) is the equilibrium adsorption capacity in different batch, and k is the pseudo-second-order rate constant (mg/g/h).

The concentration of RAPIMER and modified lignin sorbent were fixed at 20 mg/L, and the initial PFOA and PFOS concentrations were 25, 50, 75, 100, 150, 200, 300, 400 mg/L, respectively. The batch isotherm experiments were performed in 50 mL polypropylene (PP) bottles, and the mixtures were shaken at room temperature (23±1° C.) in an orbit shaker at 150 rpm for 24 h to reach equilibrium. After 20 mins stabilization, samples were collected using 0.2 μm polypropylene syringe filters from the supernatant and were transferred to LC vials for LC-MS. Control experiments were performed in the same condition with no addition of sorbent, and no losses were observed. Experiments were performed in triplicate, due to the small variations, all points were reported. The Langmuir model (eq. 2) and Freundlich model (eq. 3) were employed to fit the adsorption reaction of PFOA and PFOS on RAPIMER and modified lignin sorbent, respectively.

$${q}_{e} = \frac{{q}_{m} b {C}_{e}}{1 + b {C}_{e}} \qquad ( 2 )$$

$${q}_{e} = {K}_{f} {C}_{e}^{1 / n} \qquad ( 3 )$$

where qₑ (mg/g) is the adsorption capacity, Cₑ (mg/L) is the equilibrium concentration, qₘ (mg/g) is the maximum capacity of adsorbate required to form a complete monolayer on the surface and b is the Langmuir constant. Cₑ qₑ was plotted against Cₑ and the data was fit to linear regression model, qₘ and b constants can be calculated from the slope and intercept. The Freundlich constant K_{f} is related to the adsorption capacity of the materials, and 1/n is a constant related to surface heterogeneity. When log qₑ is plotted against log Cₑ and the data analyzed by linear regression, 1/n and K_{f} constants were determined from the slope and intercept.

The effect of pH on PFOA and PFOS adsorption was examined on the RAPIMER and modified lignin, respectively. The experiments were run at pH values of 4, 6, 8, and 10 by adding specific amounts of 0.1 M NaOH or HCl solutions. The RAPIMER or modified lignin (25 mg/L) and PFOA or PFOS solution (100 mg/L) were added to 20 mL DI water with different initial pH values in 50 mL polypropylene bottles. The bottles were shaken at room temperature (23±1° C.) on an orbit shaker at 150 rpm for 48 h. Blanks without RAPIMER nor modified lignin were run as controls. The samples were then collected from the supernatant, filtered with 0.2 μm polypropylene filters, and then transferred to HPLC-MS for further measurement. All samples were run in triplicates.

The pH point of zero charge (pHpzc) was measured as follow. The RAPIMER (25 mg) or modified lignin sorbent (25 mg) were added to 5 mL 0.1 M NaCl solutions with different initial pH values of 2, 5, 8 and 11. DI water was boiled to remove dissolved CO2 to prepare the solutions. The samples were shaken for 48 h at 150 rpm at room temperature to reach equilibrium. After the materials were completely settled, the final pH of the supernatant was measured as pHpzc of the material. The control of the different pH solutions without sorbents were performed for comparison and no change of pH value was observed. Experiments were performed in triplicates.

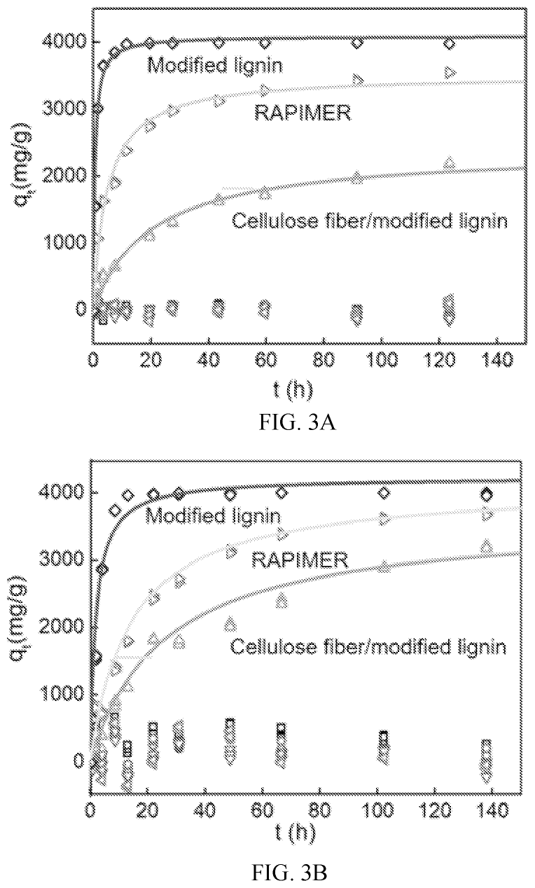

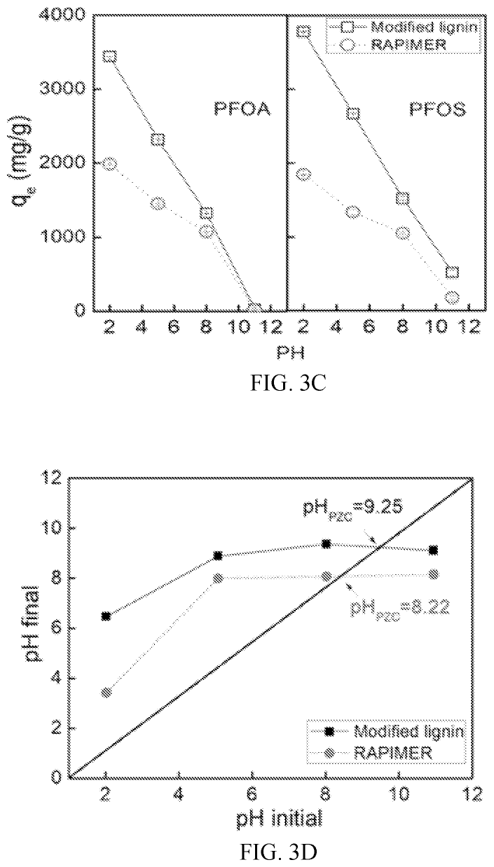

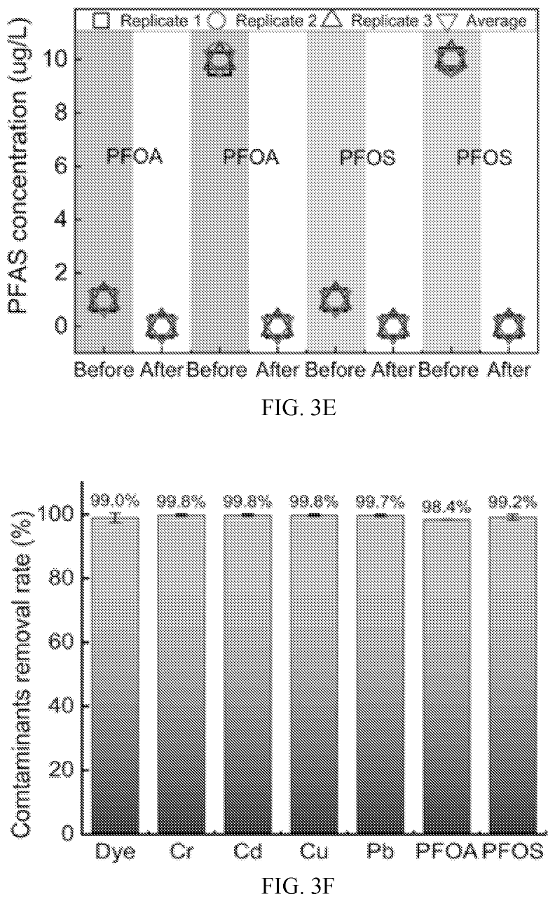

The RAPIMER and modified lignin were set up to test the low concentrated PFOA and PFOS adsorption, respectively. PFOA and PFOS solutions (20 mL) at 1 μg/L and 10 μg/L concentrations were used in a flow setting. The RAPIMER (10 mg) and modified lignin sorbents (10 mg) were separately weighed and packed into customized polypropylene syringe filters. The filters were installed on a polypropylene syringe (FIG. S8). The PFOA and PFOS solutions were pressurized via a pump to go through the syringe at a 1 mL/min flow rate. The effluent solutions were collected, filtered with 0.2 μm polypropylene filters, and then transferred to HPLC-MS for quantitative measurement. For the PFAS adsorption in the presence of co-contaminants, natural rainwater was collected in a large plastic cooler at College Station, Texas. After removing foreign objects such as leaves, insects, and large particles, the rainwater was filtered using a 0.22 μm membrane filter. Anionic dye (direct red 81), chromium (Cr), cadmium (Cd), copper (Cu), lead (Pb), and PFOA/PFOS (50:50) solutions were spiked into the rainwater to reach a final concentration of one μg/mL for each individual contaminant. The same flow setting was used for contaminant adsorption testing (FIG. S8). The influent and effluent were collected for the contaminant adsorption tests using HPLC-MS (PFOA and PFOS), optical design (OD) measurement (510 nm for dye), and ICP-MS (Cr, Cd, Cu, and Pb). The results were reported in FIG. 3F.

Filtered solutions or PFOS and PFOA standard solutions (10 μL) were loaded into a 3.0 mm×50 mm (1.7 μm) Acquity UPLC BEH C18 column (Waters, MA, USA) to separate the compounds. An ammonium acetate aqueous solution (20 mM, solvent A) and 100% Methanol (solvent B) were used as mobile phases, with a flow rate of 300 μL min⁻¹. The LC gradient starts with 95% solvent A and 5% solvent B, and this ratio was kept until 1.00 min, then increased solvent B to 100% until 12.00 min, and kept the ratio until 13.00 min. The mass spectrometer TSQ Quantiva (Thermo Fisher Scientific, San Jose, CA) was operated with a high temperature ESI source in negative mode. The ion source related parameters were spray voltage: static; negative ion: 3200 V; sheath gas: 38.3 Arb; aux gas: 1.2 Arb; sweep gas: 2.8 Arb; Ion transfer tube temp: 325° C.; vaporizer temp: 50° C.; CID gas: 1.5 mTorr. The PFAS stock solutions were prepared in methanol to a final concentration of 1 mg mL⁻¹ and stored at 4° C. The calibration solutions were diluted with water to the corresponding concentration, and all calibration solutions and samples contain the internal standards with a spiked concentration of 5 μg/L.

### PFAS Degradation Experiments

In preparation of the degradation experiments, the white rot fungus Irpex lacteus (originally isolated from Shennong Nature Reserve (Hubei, China)⁴⁶ was pre-cultured in 5 mL potato dextrose broth mounted on tissue culture plates (VWR 10861-554, Radnor, PA) at 28° C. for 7 days. The cultivation conditions followed procedures in the report²⁷. Before inoculating onto different materials, fungal mycelium was washed three times with DI H₂O, then dispersed in 5 mL Kirk medium²⁶ without glucose. The engineered material was then placed into the 5 mL Kirk medium without glucose on a 12 well plate to monitor the fungus growth. The as-produced composite materials, in this case, served as the sole carbon source for the fungus to grow. Kirk media with glucose was used as the control to compare the fungal growth on the engineered materials. The supernatant was filtered and tested by high resolution LCMS analysis for PFAS degradation products.

### Material Characterizations

During the process materials were characterized at several stages to identify chemical and other characteristics. Atomic Force Microscopy (AFM) analysis of cellulose nanofibrils and cellulose fibers were generated using a Bruker Dimension Icon Atomic Force Microscopy (Billerica, MA). To examine the presence of chemical functional groups, Fourier Transform Infrared Spectroscopy (FTIR) spectra were generated using Thermo Nicolet 380 FTIR spectrometer (Thermo Fisher) in the wavelength range from 400 to 4000 cm⁻¹. Chemical element and chemical bonding were examined based on X-Ray photoelectron spectroscopy (XPS) spectra developed using Omicron CPS/UPS system with Argus detector and the Omicron's DAR 400 dual Al X-ray source (power of 300 W) (Scienta Omicron, Uppsala, Sweden). Scanning electron microscopy (SEM) images were recorded on a Tescan FERA-3 Model GMH Focused Ion Beam Microscope (Brno, Czech Republic) at an accelerating voltage of 5 kV. Atom number and element weight ratio for major elements such as C, N, O, F, S of samples were measured by XPS and EDS. Thermogravimetric analysis (TGA) test was performed on a TA instrument TGA 5500 (TA Instruments, New Caste, DE) thermogravimetric analyzer. About 5.0 mg of a sample was heated from room temperature to 700° C. at a heating rate of 10° C. under N2 atmosphere. The method to calculate the density and porosity of these composite foams according to the solid density (cellulose nanofibrils density is 1.45 g/cm³ and cellulose fiber density is 1.6 g/cm³) and their volumes were previously reported⁴⁷⁻⁴⁹. The specific surface areas of the cellulose fibers and cellulose nanofibrils were calculated according to their carboxylic content and cationic demand⁵⁰.

### Fungal Viability Assay

Fungal viability was assessed by evaluating the extractable fungal proteins on different materials. A SpeedVac (Thermo Fisher) was used to remove the liquid solution from the fungus growing material after collecting the growing solution. 100 μL 0.5 M NaOH was then added onto the material. The resulting material solution mixture was boiled for 5 mins. 100 μL of 0.5 M HCl was added before centrifuging at 12,000 rpm to obtain the protein supernatant. The 50 μL supernatant was added into 1 mL of Bradford solution for OD₅₉₅ measurement and construction of the standard curve to quantify the protein concentration. 1.5 μL DI water was added into 1 mL Bradford solution for comparison as control. For the Bradford protein quantitative measurement, 0.1 mg/mL, 0.2 mg/mL, 0.4 mg/mL, 0.6 mg/mL, 0.8 mg/mL and 1 mg/mL BSA solution was added into the 1 mL Bradford solution and mixed well to construct the calibration curve. For fungal viability growing on different materials, the fungal samples were collected to evaluate protein concentration on days 1, 3, 7, and 14. For the fungal viability on the PFAS enriched RAPIMER at different PFAS concentrations, the fungal samples were collected to test protein concentration on days 1, 3, 7, 10, and 14. The RAPIMER composition treated with 10 μg/L, 100 μg/L, 1000 μg/L, and 10,000 μg/L of the PFOA/PFOS mixture solution were employed to analyze the concentration effect of PFAS on Fungus growth. Kirk media with glucose was used as the control in the fungal viability assay.

Extracting Protein from the Fungus for Proteomics Analysis

The mycelia of the white rot fungus grown on the engineered materials were collected by centrifuging at 8500 rpm, washed twice with DI H₂O, and briefly dried with tissue paper. 100 mg of the harvested mycelium sample was then ground in liquid nitrogen and boiled for 10 min in 1 mL Alkali-SDS buffer (5% SDS; 50 mM Tris-HCl, pH 8.5; 0.15 M NaCl; 0.1 mM EDTA; 1 mM MgCl₂; 50 mM Dithiothretiol)⁵¹. The supernatant of the boiled sample after centrifuging at 6600 rpm for 10 min was transferred to a fresh tube. To each tube, 100% chilled trichloroacetic acid (TCA) was added to a final concentration of 20%. The solution was mixed well and incubated at −20° C. for 2 hours. Samples were centrifuged at 15000 rpm for 30 min at 4° C. to remove the supernatant. The pellet was harvested and washed twice with 1 mL chilled acetone following centrifuging at 15000 rpm for 30 min at 4° C. The protein pellet was air-dried and then dissolved in a solution buffer contains 7 M urea, 2 M thiourea, 40 mM Trizma base, and 1% 3-(4-Heptyl) phenyl-3-hydroxypropyl dimethylammoniopropanesulfonate (C7BzO). The extracted protein pellet was stored at −80° C. prior to LC-MS/MS analysis.

### Protein Analysis Via MudPIT Based Shot-Gun Proteomics

MudPIT-based shot-gun proteomics was carried out to analyze the extracted proteins. Approximately 100 g of protein was digested by Trypsin (Mass Spectrometry Grade, Promega, WI, USA) with 1:40 w/w at 37° C. for 24 h. The digested peptides were desalted using a Sep-Pak Plus C18 column (Waters Limited, ON, Canada) and loaded onto a biphasic (strong cation exchange/reversed-phase) capillary column using a pressure tank. The 2D back column was composed of 5 cm of C18 reverse-phase resin (C18-AQ, The Nest Group, Inc, Southborough, MA, USA) and 3 cm of strong cation exchange (SCX) resin PolySULFOETHYL A, (The Nest Group, Inc, Southborough, MA, USA). The back column was then connected to a 15-cm-long 100 μm-ID C18 column (packed in house with the same C18 reverse-phase in the back column) and sprayed through a SilicaTip (New objective, Inc, Woburn, MA). The two-dimensional liquid chromatography (LC) separation and tandem mass spectrometry conditions followed the protocols, previously described by Washburn et al.⁵². Before SCX separation, a 1 h reverse phase (RP) gradient from 100% Solvent A (95% H₂O, 5% acetonitrile (ACN), and 0.1% formic acid) to 100% Solvent B (30% H₂O, 70% ACN, and 0.1% formic acid) was configured to move peptides from C18 resin to SCX resin in the back column. The SCX LC separation was performed with eleven salt pulses containing increasing concentrations of ammonium acetate. Each salt pulse was followed by a 2 h reverse-phase gradient from 100% Solvent A to 60% Solvent B. The LC eluent was directly nanosprayed into a Thermo Fisher Orbitrap Velos Pro mass spectrometer (Thermo Fisher Scientific). The mass spectrometer was set to the data-dependent data acquisition mode. Full mass spectra were recorded on the peptides over a 300-1700 m/z range, followed by five tandem mass (MS/MS) events for the most abundant ions from the first MS analysis. The Xcalibur™ software (Thermo Fisher Scientific) was used to control the LC-MS system and collect the data.

### Proteomics Data Analysis

Tandem mass spectra were extracted from the raw files and converted into the MS2 file. The Irpex lacteus proteome and functional annotations were obtained from MycoCosm⁵³. The MS2 file was searched against the filtered models which contain one representative protein per gene locus of the 15,319 gene models from the I. lacteus genome⁵³. A ProLuCID algorithm with precursor tolerance of 50 ppm was used to search for data using the Texas A&M High Performance Research Computing clusters⁵⁴. The peptide spectrum matches (PSMs) were filtered through a target-decoy strategy using a semi-supervised machine learning algorithm Percolator with false discovery rate cutoff as 0.1⁵⁵. Spectral counts for each detected protein were computed by crux spectral-counts function⁵⁶. Differential protein expression analysis was performed by R Bioconductor package “DEP” using the raw spectral counts⁵⁷. Proteins expressed in at least two samples were retained. The missing values including missing at random and missing not at random were computed by “knn” method and “MinProb” method, respectively. Row counts of 4,876 detected proteins were normalized by variance stabilizing normalization. Significantly differentially expressed proteins were identified with adjusted p-value<0.1 and fold change >2. The normalized log 2 spectral count of the proteins was used to represent their expression levels at each condition. Gene ontology (GO) enrichment of differentially expressed proteins was conducted under the detected protein background using BiNGO in Cytoscape^{58,59}

### Environmental Assessment

The multi-dimensional LCA analysis was conducted using OpenLCA 1.10.3 software (see worldwide website: openlca.org/). A cradle-to-gate system boundary was defined. The inventory data used was primarily adopted from the Ecoinvent 3.7 database. Two functional units were specified to facilitate the comparisons with alternative sorbents, 1) environmental impacts per kg of produced sorbent materials; and 2) environmental impacts in treating 1 m³ of PFAS contaminated groundwater.

A cradle-to-gate, multi-dimensional, life cycle assessment (LCA) was carried out to quantify the environmental impacts of RAPIMER production and use. We examined environmental impacts acidification, greenhouse gas emissions, human toxicity (cancer and non-cancer), ecotoxicity, ozone depletion, particulate matter, and surface ozone formation. The analysis was done using OpenLCA 1.10.3 software over data primarily adopted from the Ecoinvent 3.7 database. For comparative purposes, we examined the RAPIMER results with that from two commonly proposed PFAS sorbents, namely activated carbon and ion exchange resins.

We performed two sets of comparisons. First, we directly compared the environmental impacts for producing one kg of the respective sorbent. Second, we normalized the comparison by examining the environmental impacts in treating 1 m³ of PFAS contaminated groundwater (with a PFAS concentration rate of 0.21 g/L) using each of the three sorbents⁶¹. Particularly, we factored in sorbents' different adsorption capacities in doing the normalization. For instance, the equilibrium adsorption capacity of the RAPIMER ranges between 3.53 to 4.15 kg PFAS/kg sorbent for PFAS (PFOA and PFOS), which is much higher than that of activated carbon at 0.4-0.42 kg/kg^{62,63} and anion exchange resin at 1.5-3.07 kg/kg^{64,65}, respectively. Mathematically, the calculation takes the form as follows.

$${NEI}_{w e} = {EI}_{w e} \times \frac{c}{{cap}_{w}}$$

where w indicates the sorbent form (RAPIMER, activated carbon, or ion exchange resins) and e the form of environmental impact, such as, for example, greenhouse gases and ozone. EI_{we} refers to the environmental impacts of type e arising when producing one kg of sorbent w as we discuss further below. c is the total PFAS contained in the polluted groundwater; that is 0.21 μg/L×1000 L=0.00021 kg. cap_{w} denotes the sorbent equilibrium adsorption capacities in terms of kg PFAS absorbed per kg of sorbent. For that we used the mean of its absorbent capacity range (i.e., 3.84 kg PFAS per kg of RAPIMER, 0.41 kg PFAS per kg of activated carbon, and 2.28 kg PFAS per kg of anion exchanged resins)^{62,63,64,65} Finally, NEI_{we} is the resultant computation for environmental impact of type e for the inputs used in making the sorbent for treating 1 m³ of PFAS contaminated groundwater. For RAPIMER we took the amounts of each of the chemicals and other inputs used to make 1 kg of sorbent using the items listed in the methods section. We then looked up their multi-dimensional impacts (e) from the Ecoinvent 3.7 database then added across all inputs to get the multi-dimensional environmental impact vector per kg of RAPIMER. For activated carbon and anion exchanged resins we drew the impact vector per kg directly from the Ecoinvent database 3.7.1⁶⁶. For computing emissions related to energy use, we assume the electricity employed was clean and renewable (i.e., hydrological power), which is line with the “net-zero” emission initiatives to combat climate change⁶² (Table 5).

TABLE 5
Information on the input material to produce 1 kg of the RAPIMER

| | | | |
|---|---|---|---|
| Input Material | Quantity | Unit | Inventory data |

Agricultural residue

| | | | |
|---|---|---|---|
| Corn stover | 2.5 | kg | USLCI |

Chemical input

| | | | |
|---|---|---|---|
| Sodium hydroxide | 275 | g | Ecoinvent 3.7 |
| Polyethylenimine (PEI) | 160 | g | Ecoinvent 3.7 |
| Formaldehyde | 593 | g | Ecoinvent 3.7 |
| Sodium hypochlorite | 438 | g | Ecoinvent 3.7 |
| Citric acid | 50 | g | Ecoinvent 3.7 |

Energy input

| | | | |
|---|---|---|---|
| Electricity ^{a} | 27 | kWh | Ecoinvent 3.7 |

Output

| | | |
|---|---|---|
| RAPIMER | 1 | kg |

^{a} The electricity consumption during the production of RAPIMER was considered to use industrial processes (i.e. freeze-drying, and etc.). In our process, we assume the power required for drying 1 kg RAPIMER is 2.20 kWh based on the literature and actual electrical comsumption⁸⁰. The rest of electricity usage was estimated based on the watts of the equipment and the conditioning time.

All patents, patent applications, provisional applications, and publications referred to or cited herein are incorporated by reference in their entirety, including all figures and tables, to the extent they are not inconsistent with the explicit teachings of this specification.

Following are examples which illustrate procedures for practicing the invention. These examples should not be construed as limiting. All percentages are by weight and all solvent mixture proportions are by volume unless otherwise noted.

### Example 1—RAPIMER Component Design for Adsorption and Biodegradation

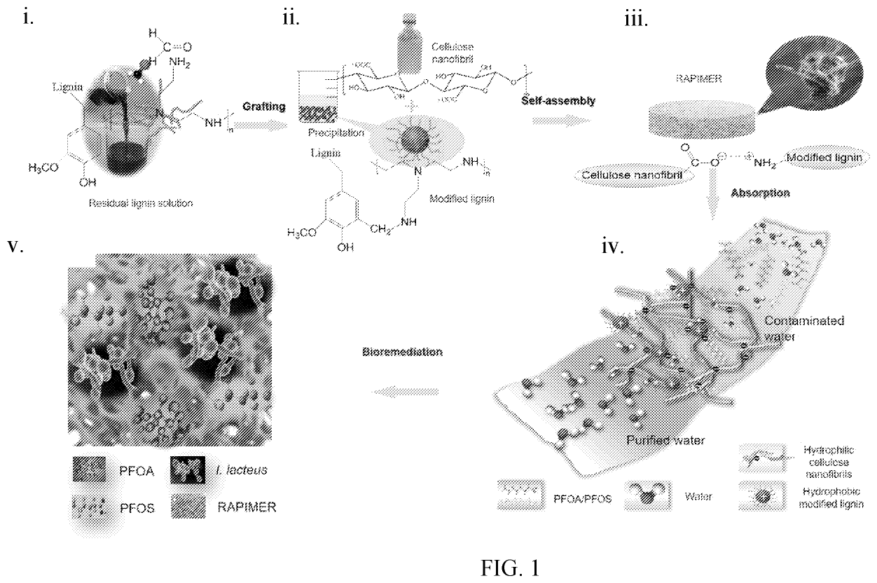

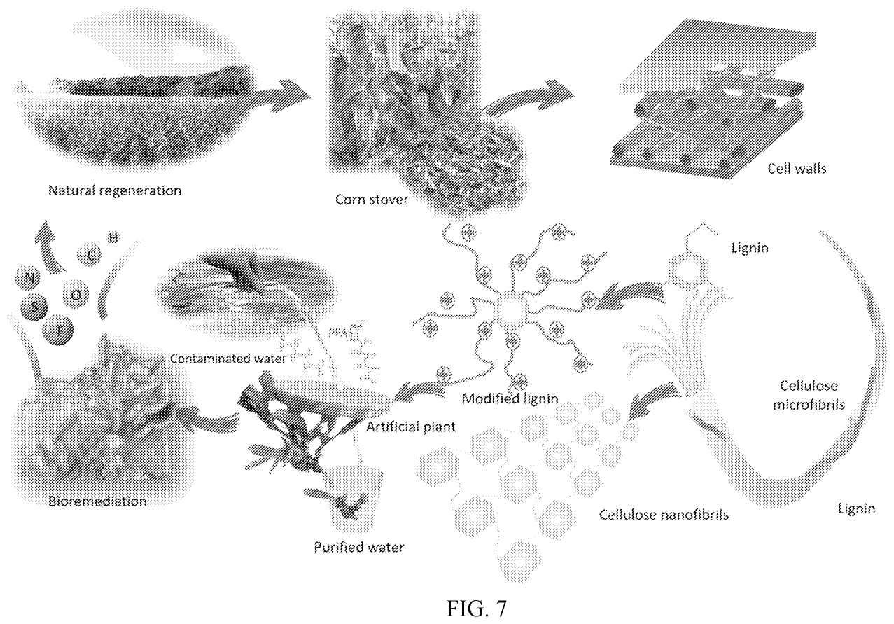

RAPIMER based remediation relies on a material that: 1) efficiently adsorbs POPs/PFAS, 2) holds the PFAS at high concentration, 3) serves as substrate for white rot fungus that carries out bioremediation, and 4) stimulates the expression of biodegradation enzymes for rapid and efficient degradation (FIG. 1; steps i through step iv, and FIG. 7). To achieve this, multi-functional composites were designed to integrate natural biopolymers lignin and cellulose in a form that achieves effective adsorption and remediation (FIG. 7). The natural biopolymers ensure seamless integration of adsorption with bioremediation, as the RAPIMER could serve the substrate that hosts white rot fungus for biodegradation^{26,27} (FIG. 1; steps i through step iv). Meanwhile, lignin and cellulose were sourced from corn stover, a widely available agricultural product.

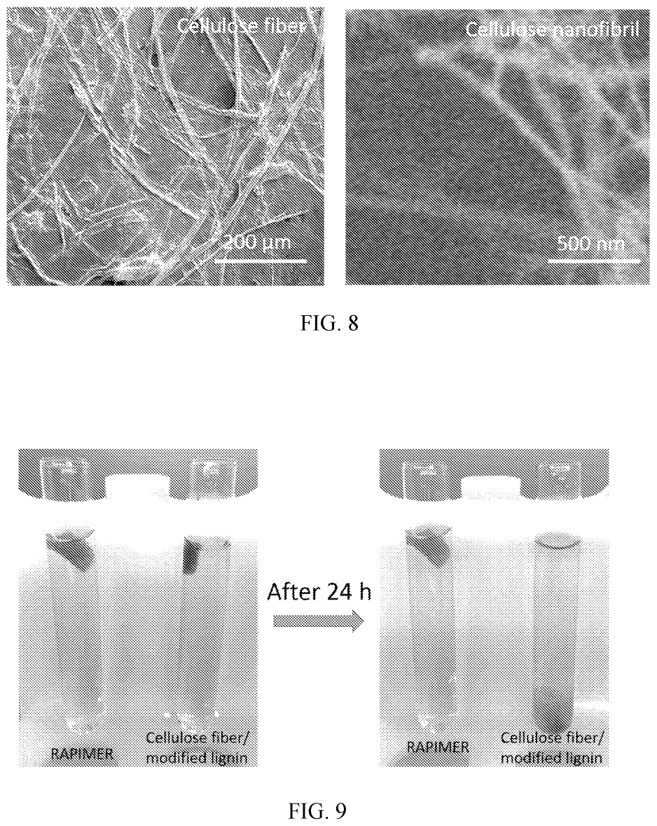

In the cellulose component design, the TEMPO-oxidation processing was used to derive cellulose nanofibrils with significantly finer diameter compared to the source cellulose fibers (FIG. 8). Furthermore, compared with cellulose fiber, the cellulose nanofibrils exhibited better hydrostability (FIG. 9) and a larger specific surface area (Table 1). Cellulose nanofibrils were therefore chosen as a component to build the RAPIMER nano-framework. As for the lignin component, the purified lignin from a residual solution of cellulose manufacturing showed no binding affinity for PFAS (Table 2). The lignin was modified by grafting it with polyethylenimine (PEI) (FIG. 1; step i), as the polyethylenimine is biocompatible and can introduce cationic interactions to enhance adsorption²⁸. This modification resulted in positively charged lignin particles²⁹ that enhanced adsorption by interacting with negatively charged PFAS molecules.

TABLE 1
Density, porosity, and specific surface area of cellulose materials

| | Bulk | Structural | Specific |
|---|---|---|---|
| | density | porosity | surface |
| Cellulose | (kg/m³) | (%) | area(m²/g) |
| Cellulose fibers | 15.59 | 99.03% | 13.10 |
| Cellulose nanofibrils | 8.65 | 99.40% | 177.96 |

TABLE 2
Calculated constants of the pseudo-second-order model of PFOA
and PFOS on the RAPIMER system, sorbents, and controls

| | | The pseudo-second-order model | | |
|---|---|---|---|---|
| Sorbents | adsorbates | qₑ (mg/g) | k | R² |
| Cellulose fiber/ | PFOA | 2410 | 2.057 × 10⁻⁵ | 0.977 |
| modified lignin | | | | |
| RAPIMER | PFOA | 3529 | 5.951 × 10⁻⁵ | 0.986 |
| Modified lignin | PFOA | 4104 | 4.355 × 10⁻⁵ | 0.992 |
| Cellulose fiber/ | PFOS | 3658 | 1.051 × 10⁻⁵ | 0.936 |
| modified lignin | | | | |
| RAPIMER | PFOS | 4151 | 1.703 × 10⁻⁵ | 0.989 |
| Modified lignin | PFOS | 4262 | 1.210 × 10⁻⁴ | 0.979 |
| Control (cellulose | PFOA | 3.9 | −0.698 | 0.193 |
| fiber/lignin) | | | | |
| Control (cellulose | PFOA | 19.4 | −0.1208 | 0.187 |
| nanofibril/lignin) | | | | |
| Control (cellulose | PFOS | 225 | 3028 | 0.150 |
| fiber/lignin) | | | | |
| Control (cellulose | PFOS | 128.1 | −689 | 0.0175 |
| nanofibril/lignin) | | | | |

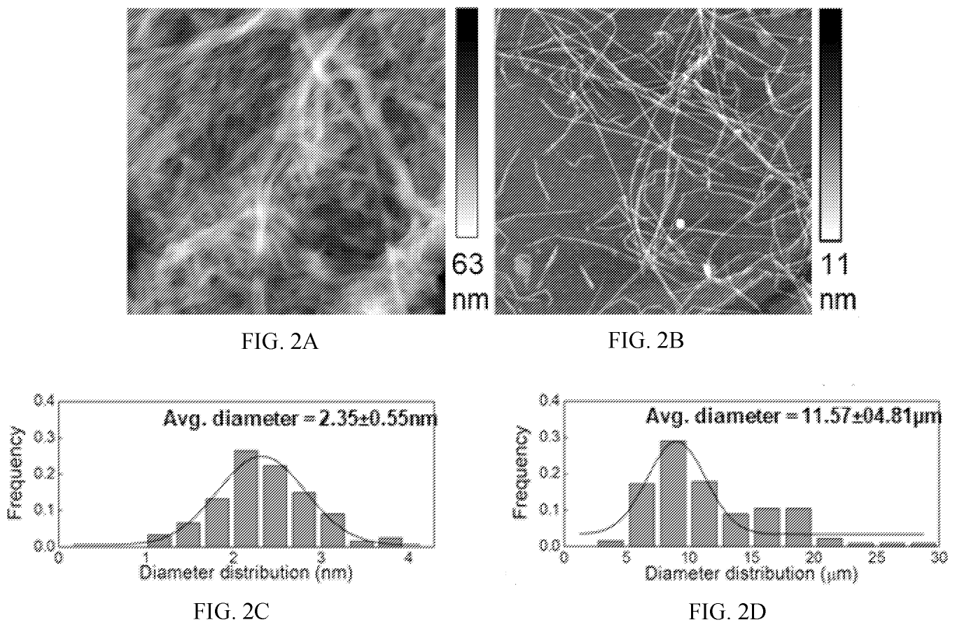

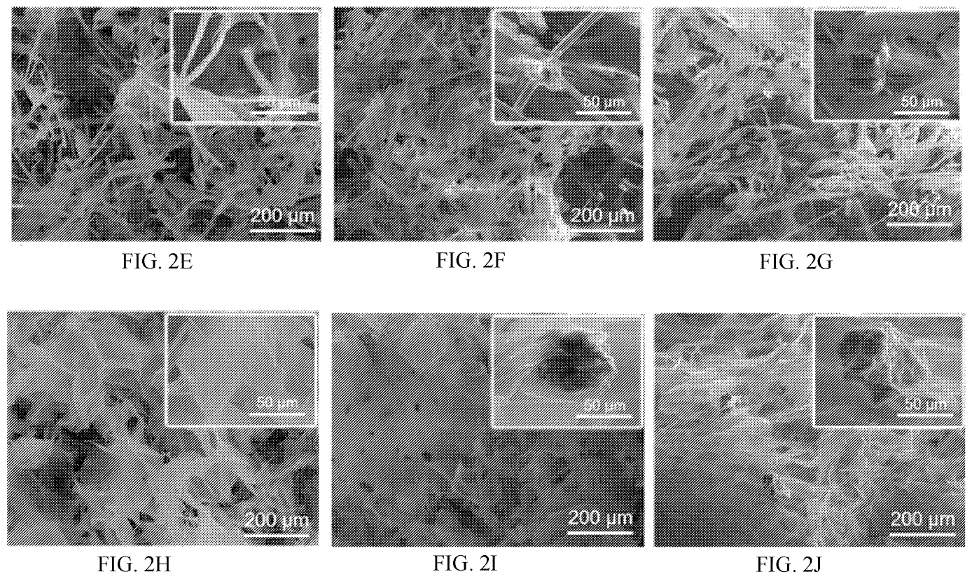

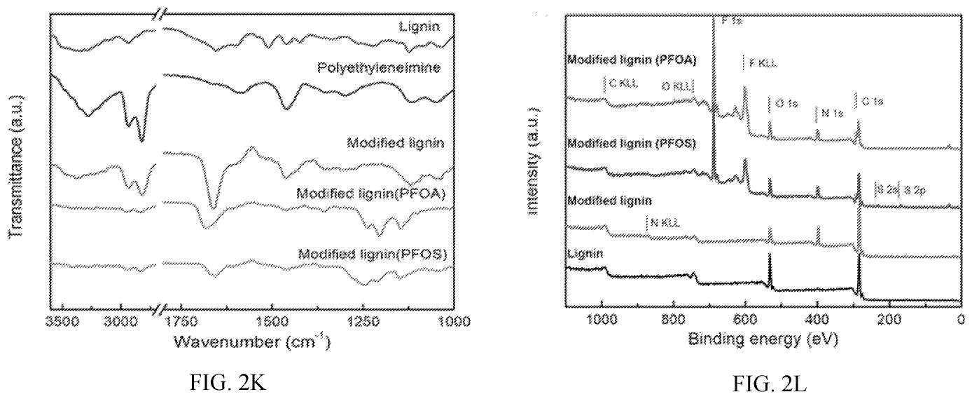

The chemically modified lignin and cellulose nanofibrils were then fabricated into a stable RAPIMER composite using freeze drying and oven curing (FIG. 1; step iii) (see Materials and Methods). The resultant RAPIMER possesses a three-dimensional (3D) nano-structure (FIGS. 2A-2L) with a large surface area for PFAS adsorption, the positively charged lignin that attracted the PFAS, and spatial accommodation for biodegrading microorganisms. Subsequently, analysis by kinetic adsorption and retention tests (FIG. 1; step iv) revealed that RAPIMER exhibited record adsorption capacity and efficiency. (See Materials and Methods). Further biodegradation assay revealed that RAPIMER can serve as a substrate for fungal growth (FIG. 1; step v) and promote the biotransformation of the stored PFAS into two, less toxic shorter chain products (C₇HF₁₃O and C₆HF₁₁O₂)³⁰.

### Example 2—3D Structural and Multi-Functional Design of RAPIMER

The 3D structural design was crucial for efficient PFAS adsorption. The RAPIMER had a finer nanoscale fiber structure compared with that of cellulose fibers (FIGS. 2A-2B, and FIG. 8) and formed a spatial lattice structure for efficient PFAS adsorption. The average fiber diameter for the resultant cellulose nanofibrils is 2.35 nm, as compared to the original 11.57 μm of cellulose fiber (FIGS. 2C-2D). This resulted in a 13-fold increase in specific surface area (Table 1).

The 3D nano-structure of RAPIMER was compared with other composites (FIGS. 2E-2J). Particularly, the cellulose fibers possessed a limited number of unconfined hydroxyl groups, whereas the cellulose nanofibrils in RAPIMER formed a flake-like 3D lattice scaffold due to the abundant hydrogen bonding among the well-distributed nanofibrils (FIG. 2H). On the contrary, the cellulose fibers possess a tube-like structure. The nano-structure of RAPIMER had an enlarged surface area, enabled a better hydrostability, and provided a hydrostable framework for high capacity PFAS adsorption.

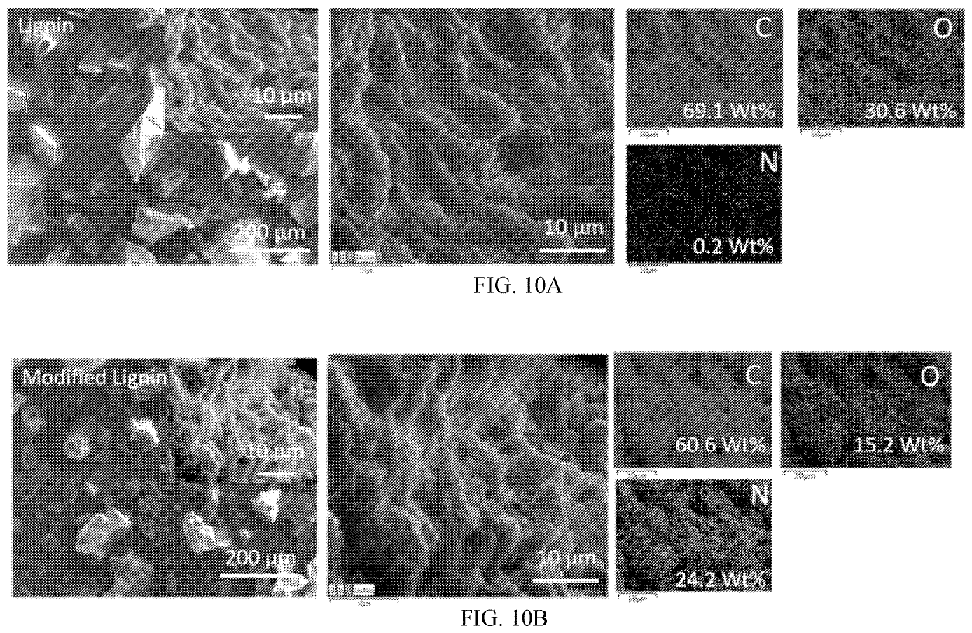

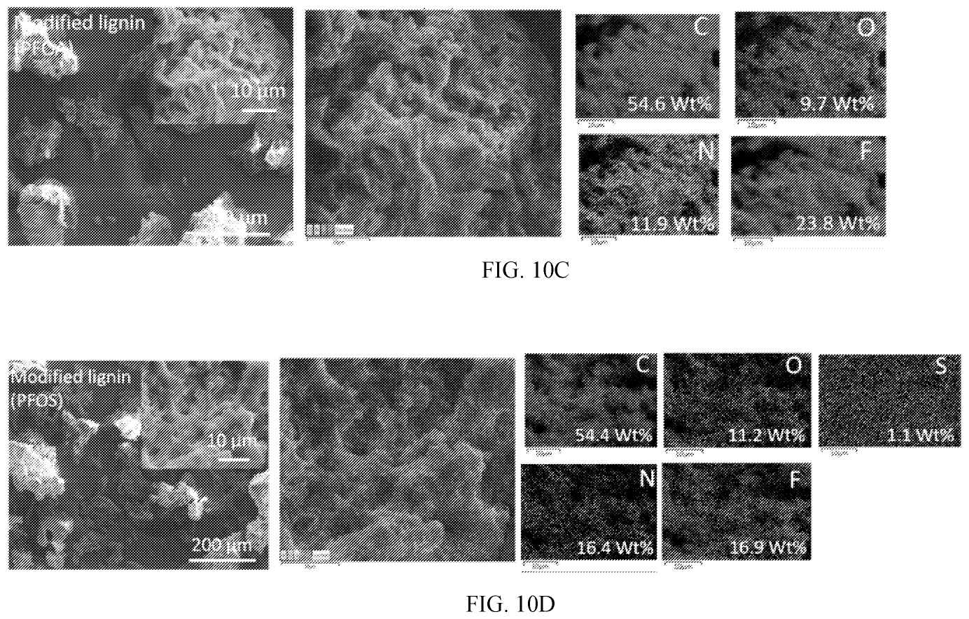

Chemically modified lignin was imbedded in cellulose nanofibril foam to form the RAPIMER for efficient adsorption and bioremediation integration as a biomimetic substrate. Since lignin is hydrophobic, the branched polyethylenimine-modified lignin retains its hydrophobicity. FIGS. 10A-10B showed the typical SEM images of lignin and modified lignin, which had similar morphologies. However, the images from Energy-Dispersive X-ray (EDX) mapping highlighted that the modified lignin had increased nitrogen content compared to that in the unmodified lignin (increased from 0.2 wt % to 24.2 wt %). The FTIR was also employed to characterize the structural change of lignin after chemical modification. The unmodified lignin spectrum presented a band at about 3400 cm⁻¹ (the hydroxyl groups), a band at 1650 cm⁻¹ (conjugated C—O vibration), bands at 1598 cm⁻¹, 1510 cm⁻¹ and 1423 cm⁻¹ (the aromatic vibrations), bands around 1460 cm⁻¹ (C—H bending), and bands at 1218 cm⁻¹ and 1120 cm⁻¹ (stretch on the C—O linkage). After chemically grafting with polyethylenimine, the modified lignin spectrum showed the amine peak at about 3380 cm⁻¹, the C—H stretching, and scissoring bands at 2940-2830 cm⁻¹ and 1463 cm⁻¹, which were consistent with the polyethylenimine spectrum. The most significant change after chemical modification was the appearance of new peaks around 1656 cm⁻¹ and 1599 cm⁻¹, which were assigned to amide I and amide II with an O═C stretch. These bands indicated that the polyethylenimine was successfully grafted onto the aromatic ring of lignin structure, introducing abundant amine groups on the modified lignin particles. The successful chemical modification reaction was further confirmed by the XPS analysis (FIG. 2L and FIG. 11). A new signal at about 400 eV corresponding to N1s was identified in the modified lignin spectrum. The polyethylenimine grafting thus resulted in abundant positively charged amine groups on lignin and RAPIMER, which could adsorb negatively charged molecules, including PFAS.

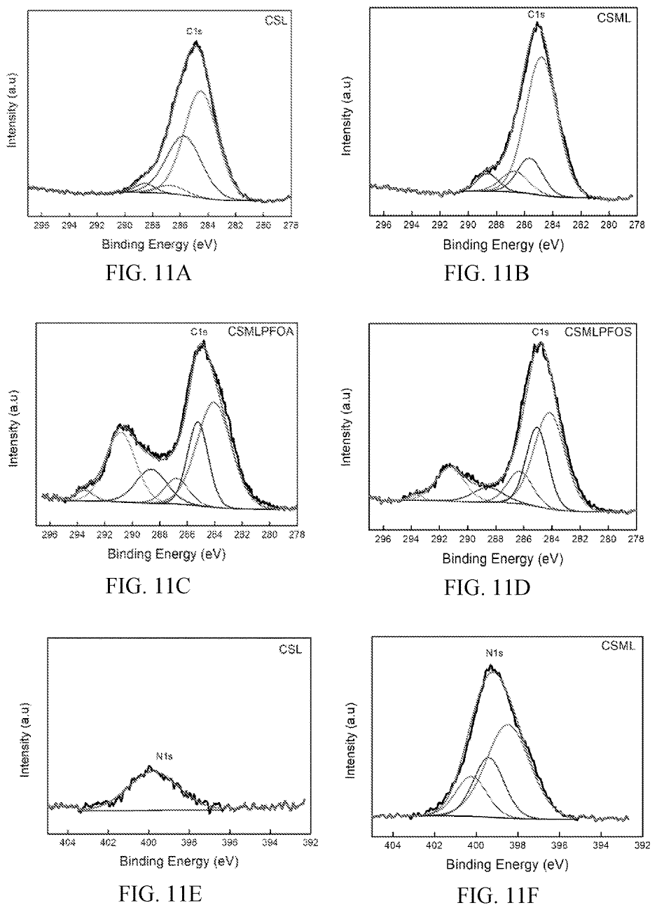

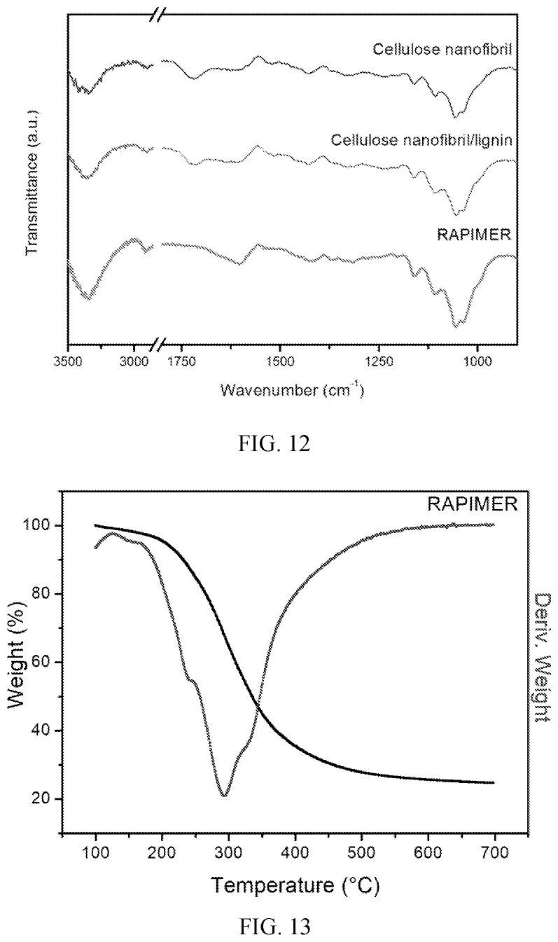

The further analysis of the FTIR spectra of the cellulose nanofibrils, cellulose fiber/lignin composite, and the RAPIMER composite (cellulose nanofibrils/modified lignin composite) were shown in FIG. 12. In the FTIR spectra, the COOH peak at 1720 cm⁻¹ (in both cellulose nanofibrils and cellulose nanofibrils/lignin composite spectra) completely disappeared in the RAPIMER spectrum. These results highlighted that the positively charged amine groups in the modified lignin reacted with the negatively charged carboxyl groups from cellulose nanofibrils. As a result, the peak at 1720 cm⁻¹ of cellulose nanofibrils shifted to 1600 cm⁻¹ in the RAPIMER spectrum. This peak transformation can be attributed to the formation of carboxylic acid/amine salt³¹. Thus, the cellulose nanofibril C6-carboxyl groups provided the anchoring sites to integrate with the modified lignin amine groups and formed the stable 3D composite structure (FIG. 1; step iii). Due to these chemical and structural changes, RAPIMER also showed excellent thermal stability and would not decompose until the temperature reached 200° C. (FIG. 13). In summary, the 3D nano-structure for RAPIMER was unique in that the negatively charged cellulose nanofibrils (hydrophilic) and the positively charged lignin (hydrophobic) generated an amphiphilic environment and a 3D lattice structure with a large surface area for highly efficient PFAS adsorption.

### Example 3—Record Adsorption Efficiency for Pfas and Co-Contaminant Removal

One important feature is the RAPIMER adsorption capacity, which was examined using adsorption kinetics analysis. The RAPIMER composite reached PFOA and PFOS adsorption equilibrium within 30 hours and 45 hours, respectively (FIGS. 3A-3B, yellow-green triangle). The adsorption quantity per gram sorbent ranged between 3529 mg/g and 4151 mg/g (Table 2), which is among the largest reported adsorption among the various sorbents in the literature (Table 3).

TABLE 3
Comparison of studies on different sorbents for PFOA and PFOS removal from water

| | | | Adsorption | Time to | | |
|---|---|---|---|---|---|---|
| | | Initial PFAS | Capacity | maximum | | |
| | Target | Concentration | (Qₘₐₓ | adsorption | | |
| Sorbent | PFAS | (mg/L) | mg/g) | n (h) | pH | Reference |
| Modified | PFOA, | 0.000001-400 | PFOA: 4104 | 5-10 | 2-11 | Our work |
| lignin | PFOS | | PFOS: 4262 | | | |
| RAPIMER | PFOA, | 0.000001-400 | PFOA: 3529 | 24-48 | 2-11 | Our work |
| | PFOS | | PFOS: 3203 | | | |
| Aminated rice | PFOA, | 10-15 | PFOA:1030 | 3-6 | 4-11 | ⁶⁷ |
| husk | PFOS | | PFOS: 1325 | | | |
| MWCNTs- | PFOA, | 0.05-10 | PFOA: 405.8 | 3 | 6.5 | ⁶⁸ |
| electrode | PFOS | | PFOS: 505.7 | | | |
| Oxidized | PFOA, | 0.05-50 | PFOA: 132.5 | 10 | 5 | ⁶⁹ |
| MWCNTs | PFOS | | PFOS: 381.9 | | | |
| CNTs-20% | PFOA, | 0.1-10 | PFOA: 491.9 | 10 | 5 | ⁷⁰ |
| graphene | PFOS | | PFOS: 555.8 | | | |
| Activated | PFOA, | 1-200 | PFOA: 476.2 | 24 | 3-10 | ⁷¹ |
| carbon | PFOS | | PFOS: 1160.3 | | | |
| Hexagonal | PFOS, | 25-30 | PFOA: 70 | 1-3 | 7 | ⁷² |
| mesoporous | PFOS | | PFOS: 19 | | | |
| silica (HMS) | | | | | | |
| Magnetic | PFOA, | 80-90 | PFOA: 370 | 0.5-1 | 2-9 | ^{73, 74} |
| mesoporous | PFOS | | PFOS: 455 | | | |
| carbon nitride | | | | | | |
| Resin [Amb | PFOA, | 5 | PFOA: 1200 | 120-200 | 3-7 | ⁷⁵ |
| IRA-400] | PFOS | | PFOS: 200 | | | |
| Amine- | PFOA | 50-300 | PFOA 290-750 | 1-2 | 3-10 | ⁷⁶ |
| grafted Metal- | | | | | | |
| Organic- | | | | | | |
| Frameworks | | | | | | |
| (MOFs) | | | | | | |
| β-Cyclodextrin | PFOA | 400-8000 | PFOA: 300-400 | 2-5 | 3.8 | ⁷⁷ |
| Copolymer | | | | | | |
| Quaternized | PFOA, | 50--500 | PFOA: 1240 | 3-9 | 3-10 | ⁷⁸ |
| Cotton | PFOS | | PFOS: 1750 | | | |
| Chitosan- | PFOS | 50 | PFOS: 1460 | 30-50 | 3 | ⁷⁹ |
| based | | | | | | |
| molecularly | | | | | | |
| imprinted | | | | | | |
| polymer | | | | | | |
| (MIP) | | | | | | |

Component adsorption experiments showed that modified lignin was the primary constituent material that adsorbed both PFOA and PFOS (blue diamond) with cellulose not playing a role (FIGS. 3A-3B, green square and triangle). Experiments with different compositions showed a 1:1 ratio of polyethylenimine-grafted lignin to cellulose nanofibrils in RAPIMER yielded the largest adsorption capacity. The negatively charged cellulose nanofibrils could have provided the 3D structural framework to immobilize the PFAS after binding. Adjusted by the sole lignin weight, the RAPIMER lignin component showed a 71.9% and 95% increase in adsorption capacity for PFOA and PFOS compared to modified lignin particles, which exceeded performance by any type of PFAS sorbents in previous studies (Table 3).

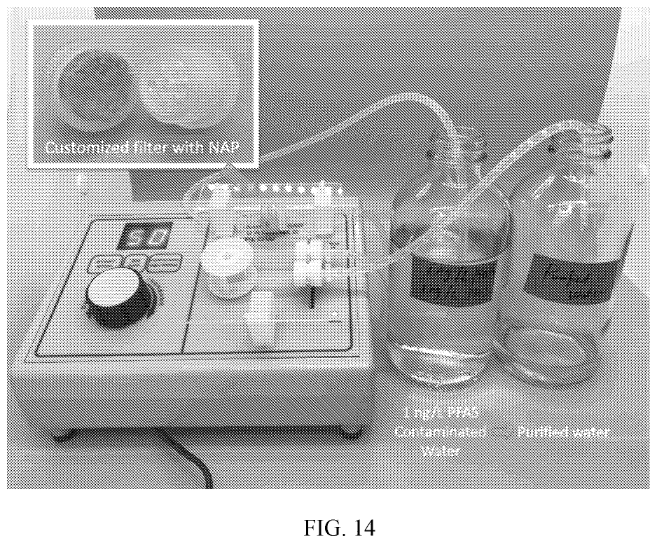

The RAPIMER adsorption was pH-dependent, where the PFAS adsorption decreases in the pH range smaller than eight (FIG. 3C and Materials and Method Section: Contaminant adsorption experiments). However, the point of zero charge of RAPIMER was 8.22, which warranted broad applications in water treatment (FIG. 3D). The RAPIMER 3D nano-structure design thus rendered both higher PFAS adsorption capacity and more adaptation to pH variations. The RAPIMER adsorption of PFAS was tested in flowing solutions containing mixed PFAS molecules (1:1 PFOA and PFOS by weight). The RAPIMER material was packed into an online filter in a flow system (FIG. 14) and subjected to filtering a PFAS solution at 1 μg/L concentration. The concentration is lower than many of the environmental relevant conditions, where PFAS are detected up to 20 μg/L or even higher concentrations³². The lower concentration is to sufficiently test the absorption capacity at low concentration. Resultant adsorption was more than 99.90% for PFOA and 100% for PFOS (FIG. 3E), indicating RAPIMER has great potential to remove trace-level POPs³³. The trace level PFAS removal uniquely enable the integration with bioremediation.

Furthermore, RAPIMER was tested for water treatment under more realistic conditions in the presence of potential co-contaminants of PFAS. Rainwater was collected, filtered, and spiked with a mixture of PFAS, heavy metals, and another organic pollutant. FIG. 3F showed the high removal efficiency of PFAS together with five other contaminants (i.e., an anionic dye molecule, chromium (Cr), cadmium (Cd), copper (Cu), and lead (Pb) at 1 mg/L for each contaminant in the rainwater) when using the same flow system (FIG. 14). The result suggested that around 99% of all the pollutants were adsorbed by the RAPIMER packed filter (FIG. 3F).

### Example 4—Mechanisms for the High Adsorption Capacity of RAPIMER and Co-Contaminant Removal

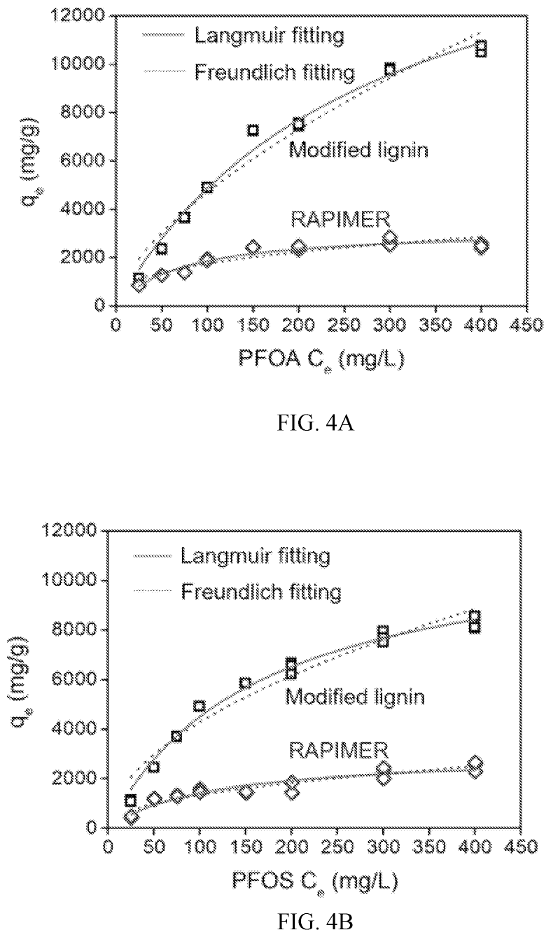

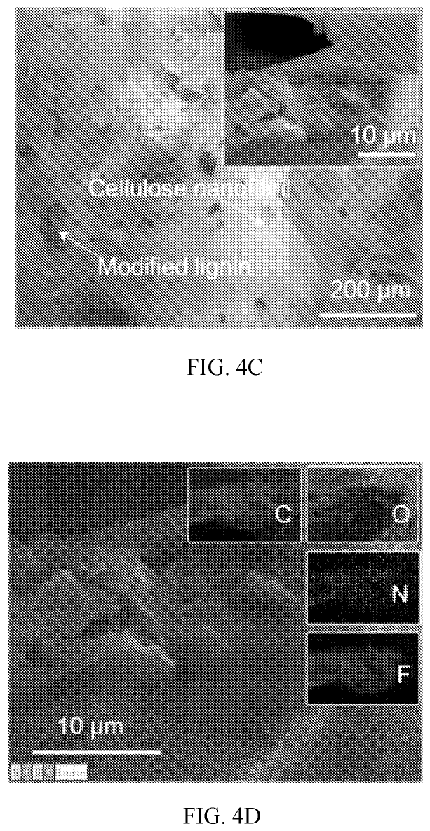

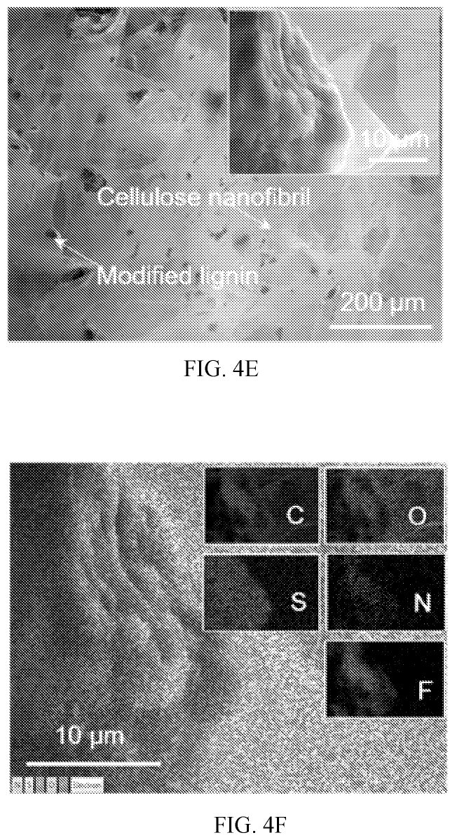

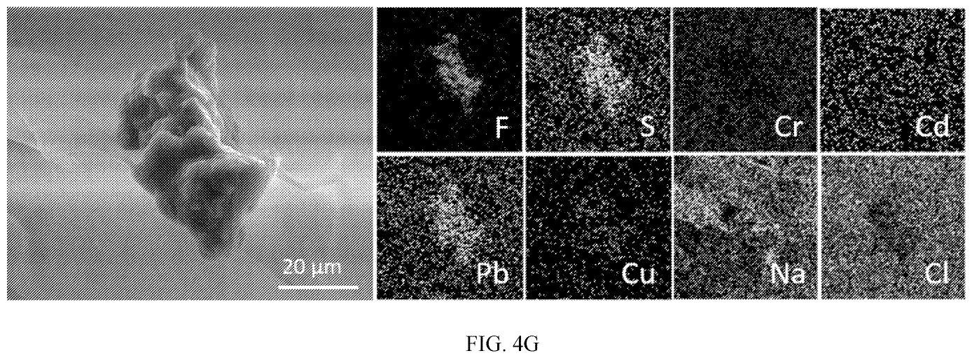

Both computational modeling and material characterization were carried out to reveal mechanisms for the high RAPIMER adsorption capacity. Using data from an adsorption isotherms test (FIGS. 4A-4B), the Langmuir and the Freundlich models were fit with the results listed in Table 4. The Langmuir model showed a better data fit, according to the resultant R² (Table 4). This suggests that the adsorption likely happened on the monomolecular layer on the RAPIMER surface due to the combined electrical charge attraction and hydrophobic interaction between PFAS and the modified lignin. Specifically, the carboxyl or sulfuric group of PFAS is negatively charged and hydrophilic, whereas the C—F chain is more hydrophobic. Therefore, the positively charged amino groups on the modified lignin provided more unconstrained sites to attract negatively charged PFAS molecules with electrostatic force. Furthermore, the modified lignin retained hydrophobicity from its lignin precursor. The hydrophobicity allows the interaction with PFAS C—F chain to further stabilize PFAS adsorption. The negatively charge of cellulose nanofibrils with a spatial lattice structure provided independent building blocks that stored the PFAS molecule adsorbed to modified lignin, which prevent the release of PFAS adsorbed to modified lignin and thus improve the total adsorption capacity. Thus, the positive charge introduced by the polyethylenimine modification, the negative charge of the cellulose nanofibrils, and the hydrophobic backbone of lignin all contributed to a 3D amphiphilic porous nano-framework to facilitate PFAS adsorption. The unique RAPIMER design has enabled significantly increased PFAS adsorption, as compared to previously reported sorbents (Table 3).

TABLE 4
Calculated constants of the Langmuir and Freundlich equations for the adsorption
of PFOA and PFOS on the modified lignin particles and the RAPIMER composite

| | | Langmuir model | | | Freundlich model | | |
|---|---|---|---|---|---|---|---|
| Sorbents | adsorbates | qₘ (mg/g) | b (mg/L) | R² | K_{f} | n | R² |
| Modified lignin | PFOA | 18529.6 | 0.0036 | 0.985 | 253.9 | 1.58 | 0.958 |
| RAPIMER | PFOA | 3203.0 | 0.0140 | 0.925 | 354.6 | 2.87 | 0.842 |
| Modified lignin | PFOS | 11876.8 | 0.0061 | 0.984 | 380.3 | 1.90 | 0.941 |
| RAPIMER | PFOS | 3000.0 | 0.0087 | 0.876 | 163.6 | 2.20 | 0.890 |

SEM (FIGS. 4C and 4E) and EDX (FIGS. 4D and 4F) analyses further confirmed the aforementioned adsorption mechanisms. Nitrogen and fluorine (N, blue color; F, purple color, see FIGS. 4D and 4F) were introduced from the grafting polyethylenimine and PFAS adsorption, and could serve as probes for lignin and PFAS localization. As shown in FIGS. 4D and 4F, the blue-purple overlapping region suggests that the modified lignin (nitrogen from polyethylenimine) interacted with PFAS (fluorine from PFAS) in a result consistent with the isothermal modeling. Thus, the high adsorption capacity of RAPIMER is a result of the universal distribution of positively charged modified lignin particles in the 3D hydrophobic and negatively charged nano-framework.

As for the adsorption of co-contaminants, the morphology and chemical element analysis (FIG. 4G) indicated that the 3D dual-electrical/amphiphilic structural design of the RAPIMER provided independent building blocks to adsorb PFAS, metals, and organic dye molecule. The SEM image showed the central CSML particle is surrounded by the CSCNF network. Moreover, the EDX images showed that the fluorine and metals were trapped by different RAPIMER components (CSML and CSCNF). The fluorine distribution image (FIG. 4G) indicated PFAS were adsorbed primarily onto CSML as shown in the image center, considering that PFAS are the only chemicals containing fluorine. The adsorption of the anionic organic dye and positively charged metal ions are more universally distributed in RAPIMER. The EDX analysis demonstrated the diverse adsorption capacity could be attributed to the 3D dual-electrical/amphiphilic structure design, which had the potential to remove PFAS in a complex matrix and remediate a large range of environmental contaminants under realistic conditions.

FTIR and XPS analyses provided additional information on the PFAS adsorption mechanism. The FTIR analysis (FIG. 2K) showed the spectra changes in the modified lignin upon adsorbing PFOA and PFOS. The amine band (around 3380 cm⁻¹) disappeared, and new major peaks of —CF₂, —CF₃ occurred around 1238 cm⁻¹, 1205 cm⁻¹, and 1150 cm⁻¹. Meanwhile, peaks of —COO⁻ (1681 cm⁻¹, for PFOA) and —SO₃⁻ (1215 cm⁻¹, for PFOS) were observed in the lignin spectra after PFOA and PFOS adsorption. The analysis thus further confirmed that the amine groups in the modified lignin were the primary functional groups to capture PFAS by the electrostatic interactions. The XPS spectra of modified lignin before and after PFAS adsorption also confirmed the interaction between the materials and PFAS (FIG. 2L and FIG. 13). The new primary peak at 689 eV (F1s peaks in PFAS adsorbed modified lignin spectra) suggested a stable and robust interaction between the modified lignin and PFAS. Overall, the results highlighted the effectiveness of the nano-structural and chemical design of RAPIMER to create a unique amphiphilic nano-porous composite material that can bind PFAS with electrostatic interaction and further stabilize this binding by the hydrophobic interaction and negatively charged environment. The large surface area of the cellulose nanofibril framework further improved the adsorption capacity to achieve the highest reported adsorption capacity.

### Example 5—RAPIMER Sustained Fungal Growth

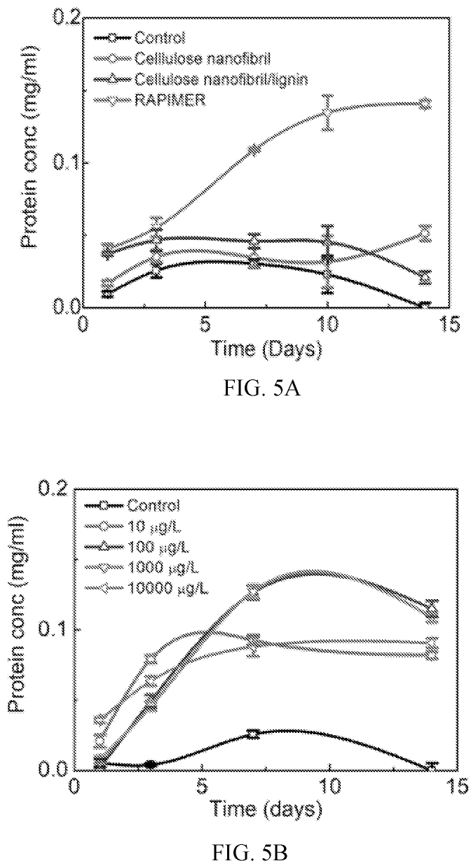

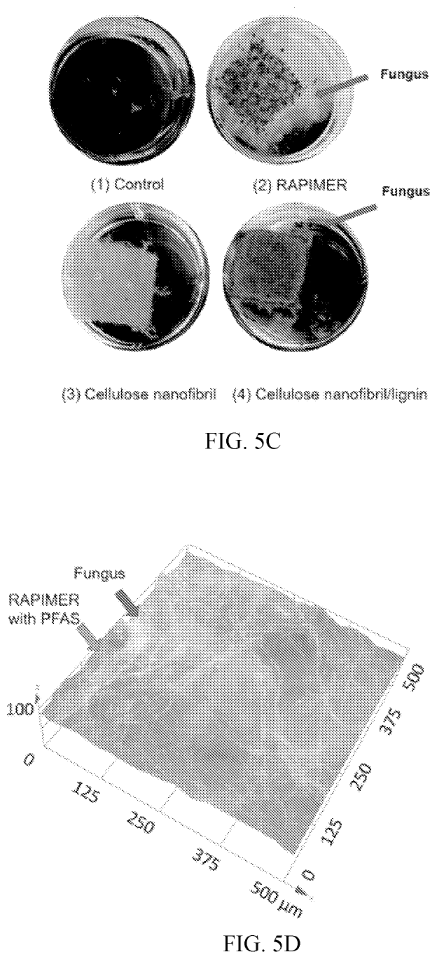

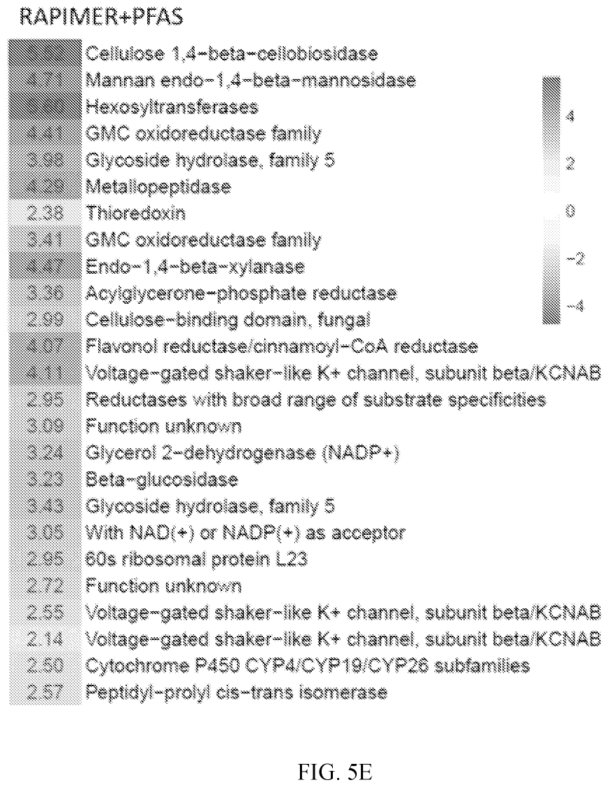

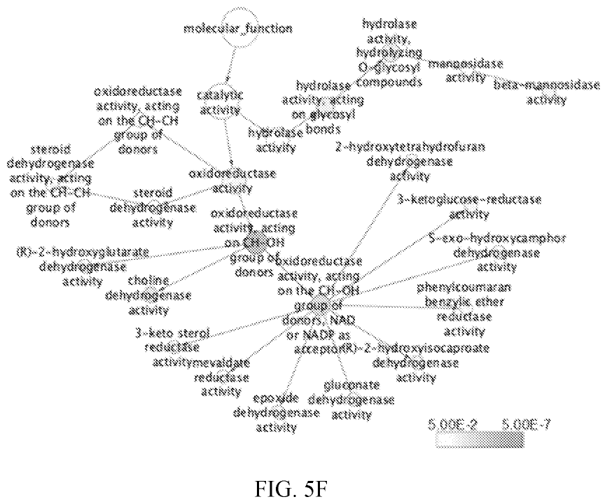

RAPIMER was found to provide essential nutrients to maintain fungal growth, allowing the integration of adsorption and biodegradation as a sustainable treatment train approach. White rot fungus Irpex lateus has been widely used in bioremediation³⁴ and it can efficiently degrade POP compounds (organic dyes) in the presence of lignin, which serves as a natural recalcitrant substrate to induce the redox enzymes for efficient bioremediation^{26,27}. FIGS. 5A and 5B show fungal growth as measured by a fungal viability assay based on fungal protein quantitation (see Materials and Methods for details of the fungal viability assay). Among the tested bioinspired composites, I. lacteus grew best on the RAPIMER composite at a 1:1 ratio of cellulose nanofibril to lignin. Less I. lacteus mycelium was found on the cellulose nanofibril/lignin composite, followed by cellulose nanofibrils during the two-week evaluation period (FIGS. 5A and 5C). After adjusting the polyethylenimine content, the optimized degrading RAPIMER composite had a cellulose nanofibril to lignin ratio of 5:3, which is consistent with levels found in natural plant cell walls^{35,36}.

Fungal growth conditions were further evaluated on RAPIMER composites treated with PFAS at various concentration levels (10, 100, 1000, and 10,000 μg/L, see Materials and Methods). I. lacteus grew well on RAPIMER treated with all four concentrations, with a better performance on the intermediate PFAS concentrations (100 and 1,000 μg/L; FIG. 5B), as shown by fungal viability assay. Digital microscopy also revealed the fungus hypha positioned well on the RAPIMER material surface (FIG. 5D). Overall, RAPIMER was found to be effective at sustaining fungal cell growth and presenting concentrated PFAS to fungal bioremediation.

### Example 6—PFAS Degradation in RAPIMER

To be useful in remediation, the RAPIMER needs to promote PFAS degradation. The fungal growth on PFAS-concentrated RAPIMER suggested the degradation capability. High-resolution mass spectrometry analysis was employed to quantitatively measure PFAS-derived products in the growing solution. Two biotransformed products were identified (C₇HF₁₃O and C₆HF₁₁O₂) as a result of degradation in the two-week evaluation period. The two compounds could be perfluoroheptanal (C7) and perfluorohexanoic acid (PFHA, C6) (M/Z at 346.9839 and 312.9723, individually). Previous studies by Mahapatra et al. and others have shown that the shorter chain PFBA (C₄), PUPA (C5), and PFHA (C6) are much less toxic than the PFOA (C₈), suggesting the degraded products detected in this study are potentially less toxic than PFOS and PFOA^{30,37}. These results highlighted the feasibility using RAPIMER to integrate the treatment train via adsorption and subsequent bioremediation to treat heavily PFAS contaminated media.

### Example 7—Molecular Mechanisms Causing RAPIMER-Induced Pfas Biodegradation

We carried out systems biology proteomics analysis to reveal the molecular mechanisms behind PFAS biodegradation (See Materials and Methods). Proteomics analysis was performed on four different fungal growth conditions (i.e., I. lacteus grew on cellulose nanofibrils, cellulose nanofibrils/lignin composite, RAPIMER, and PFAS enriched RAPIMER). Previous results suggested that lignin is a recalcitrant natural substrate that enhances fungal organic azo dye degradation due to overexpression of redox enzyme network^{26,27}. Results above suggested that lignin can synergize fungal biotransformation, yet PFAS also induces the expression of detoxification enzymes. FIG. 5E lists the top ranked differentially expressed proteins in the PFAS enriched RAPIMER compared to RAPIMER alone. We found that protein categories hydrolase, dehydrogenase, oxidoreductase, thioredoxin, reductases, and defense related enzymes were overexpressed in the PFAS enriched RAPIMER and exhibited several features. First, the overexpression or presence of defense related enzyme cytochromes P450 in the PFAS treatment condition suggested that cytochrome P450 enzymes could be involved in PFAS transformation in fungus. P450 enzymes were known for detoxification functions and bioremediation potentials and were also suggested for a potential role in PFAS transformation³⁸. Second, the general category of oxidoreductase was up-regulated. In fact, gene ontology analysis (FIG. 5F) highlighted that two types of oxidoreductases (NADPH/NADH-dependent or not) were differentially regulated. Some of these oxidoreductases synergize with cytochromes and catalyze the monooxygenase reaction (RH+O₂+2e⁻+2H⁺→ROH+H₂O) by forming the CH—OH group, assisting the PFAS biotransformation reactions. Third, the overexpression of redox enzymes and detection of C7 and C6 metabolites is consistent with the previously reported “one carbon (—CF₂⁻) removal pathways”³⁹. This overexpression suggested that the fungal cells adapted to the oxidative stress, allowing the RAPIMER composite to achieve a higher degradation capacity⁴⁰. Fourth, the cellulose and xylose deconstruction enzymes were significantly over-expressed in the PFAS-containing RAPIMER. The cells might need to mobilize more carbon source for biodegradation. More importantly, the results highlighted that the RAPIMER can be degraded by fungus efficiently. Overall, the systems biology analysis highlighted that RAPIMER synergized with the fungal growth to induce the redox biocatalytic network, in turn promoting PFAS degradation. RAPIMER also provided a solid substrate to allow the fungus to adapt to a highly PFAS concentrated environment uniquely enabling the integration of treatment train.

### Example 8—Environmental Benefits of RAPIMER Remediation

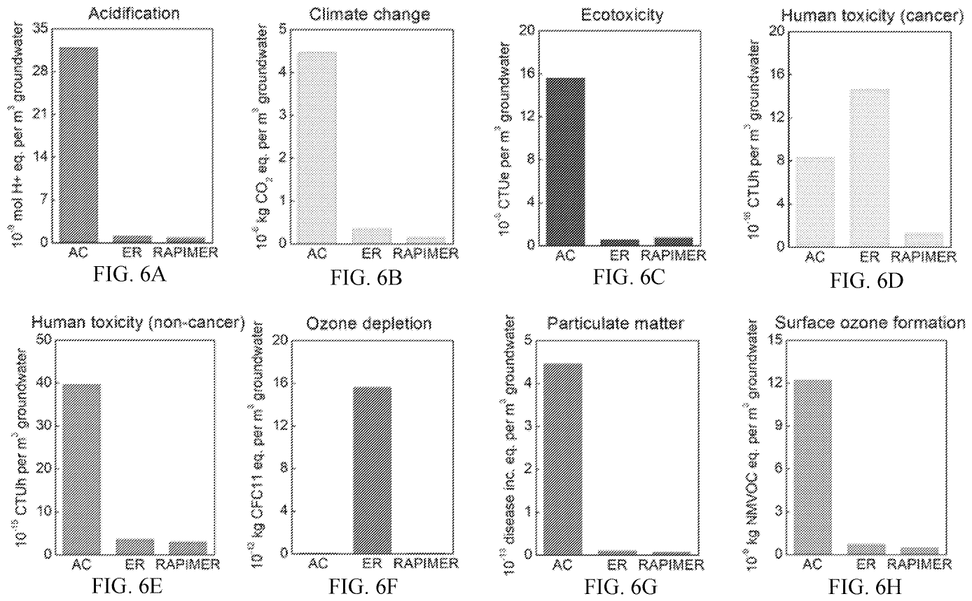

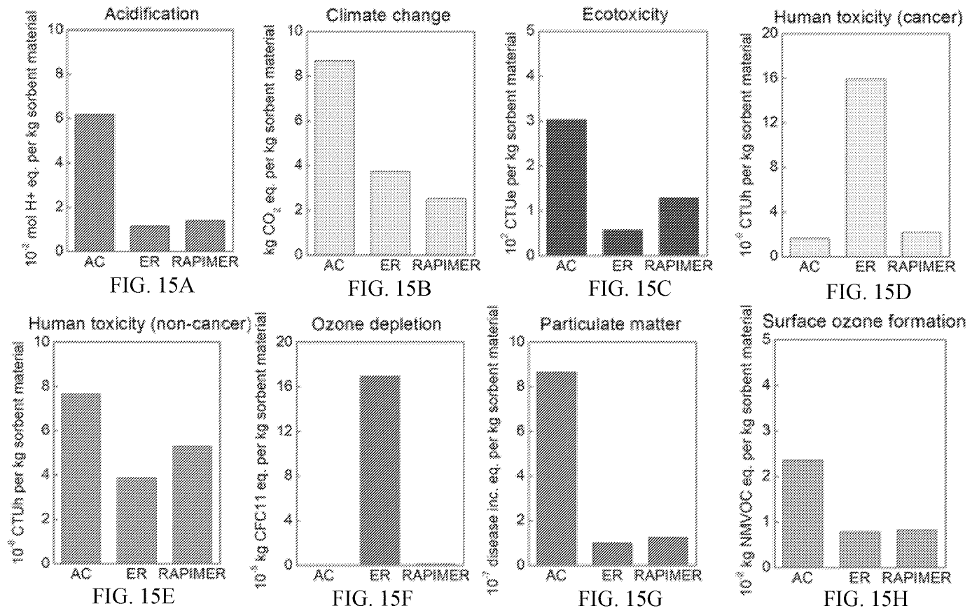

The environmental implications of RAPIMER use were investigated using a multiple dimensional life cycle assessment (LCA) in comparison with other commercially utilized PFAS sorbents (see Materials and Methods section and Table 5). The PFAS sorbents we considered involved activated carbon and ion exchange resins⁴¹. Our LCA analysis examined acidification, greenhouse gas emissions, human toxicity (cancer and non-cancer), ecotoxicity, ozone depletion, particulate matter, and surface ozone formation. Specifically, we compared the results in a normalized manner; that is, we examined the environmental impacts in treating 1 m³ PFAS contaminated groundwater (with a concentration rate of 0.21 g/L) using each of the sorbents (note that a comparison based on 1 kg of produced sorbent was also performed, see FIGS. 15A-15H). In doing the normalization, we factored in sorbents' different adsorption capacities (See Materials and Methods). For instance, we found the RAPIMER PFAS adsorption capacity is about 3- to 10-times that of the activated carbon^{42,43} and 1-time to 3-times that of the ion exchange resins (Table 6). The normalized comparison revealed RAPIMER significantly reduced net CO₂ emissions relative to activated carbon (exhibiting 1.4e-7 kg CO₂ per 1 m³ groundwater when treated with RAPIMER versus 4.5e-6 kg with activated carbon) and a moderate emission reduction compared with ion exchange resin (3.4e-7 kg). FIGS. 6A-6H also present results for the other environmental categories in comparison with those for activated carbon and ion exchange resins. Compared with activated carbon, the results in FIGS. 6A-6H show that RAPIMER use greatly lowers environmental impacts for all environmental impact categories. The use of RAPIMER also significantly outperforms exchange resins for human cancer toxicity and ozone depletion. A contribution analysis was performed and revealed the needed chemicals and production of cellulose nanofibrils component were the main contributors to the RAPIMER environmental impacts (i.e., accounting for over 70% in most of the categories). In contrast, the energy input (i.e., electricity usage) played a minor role, accounting for 3.9% of the total greenhouse gas global warning potential.

RAPIMER degradability, PFAS degradation, and the lack of secondary pollutions lead to additional environmental benefits that were not included in this LCA analysis⁴⁴. Use of less energy and no significant PFAS reemissions are also benefits relative to existing practices⁴⁵. In addition, its self-degradation alleviates the need for additional equipment and additional associated environmental burdens.

TABLE 6
The maximum adsorption capacity of typical
Sorbents and RAPIMER for PFAS

| | Isothermal maximum | |
|---|---|---|
| Sorbent | adsorption capacity(mg/g) | Ref. |
| Activated carbon | 400-415 | ^{62, 63} |
| Exchanged resin (IRA67) | 1500-3067 | ^{64, 65} |
| RAPIER | 3529-4151 | This work |

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated within the scope of the invention without limitation thereto.

### REFERENCES

1. Landrigan, P. J. et al. The Lancet Commission on pollution and health. The Lancet 391, 462-512 (2018).
2. OECD. Working towards a global emission inventory of PFASs: focus on PFASs-status quo and the way forward. Unite Nation Organisation for Economic Co-operation and Development Environment, Health and Safety Publications Series on Risk Management No 30 (2015).
3. Johnson, A. C., Jin, X., Nakada, N. & Sumpter, J. P. J. S. Learning from the past and considering the future of chemicals in the environment. Science 367, 384-387 (2020).
4. Segundo, I. D. B. et al. Development of a treatment train for the remediation of a hazardous industrial waste landfill leachate: A big challenge. Science of The Total Environment 741, 140165 (2020).
5. Guerra, F. D., Attia, M. F., Whitehead, D. C. & Alexis, F. Nanotechnology for environmental remediation: materials and applications. Molecules 23, 1760 (2018).
6. Hussain, C. M. The Handbook of Environmental Remediation: Classic and Modern Techniques. (Royal Society of Chemistry, 2020).
7. Kumari, P., Bahadur, N. & Dum6e, L. F. Photo-catalytic membrane reactors for the remediation of persistent organic pollutants-A review. Separation and Purification Technology 230, 115878 (2020).
8. Liu, Y., Wu, T., White, J. C. & Lin, D. A new strategy using nanoscale zero-valent iron to simultaneously promote remediation and safe crop production in contaminated soil. Nature Nanotechnology 16, 197-205 (2021).
9. Law, R. J. & Jepson, P. D. J. S. Europe's insufficient pollutant remediation. Science 356, 148-148 (2017).
10. Cohen, A. D. Summit briefs policy-makers on drinking water safety. Science 368, 379-380 (2020).
11. Joerss, H. et al. Transport of Legacy Perfluoroalkyl Substances and the Replacement Compound HFPO-DA through the Atlantic Gateway to the Arctic Ocean—Is the Arctic a Sink or a Source? Environmental Science & Technology 54, 9958-9967 (2020).
12. Rappazzo, K. M., Coffman, E. & Hines, E. P. Exposure to Perfluorinated Alkyl Substances and Health Outcomes in Children: A Systematic Review of the Epidemiologic Literature. Int J Environ Res Public Health 14, doi:10.3390/ijerph14070691 (2017).
13. Sunderland, E. M. et al. A review of the pathways of human exposure to poly- and perfluoroalkyl substances (PFASs) and present understanding of health effects. J Expo Sci Environ Epidemiol 29, 131-147, doi:10.1038/s41370-018-0094-1 (2019).
14. DeWitt, J. C. Toxicological Effects of Perfluoroalkyl and Polyfluoroalkyl Substances. (Humana Press, 2015).
15. EPA. US Environmental Protection Agency. PFAS structures in DSSTox. Washington, DC. [cited 2021 May 19]. Available from: https://comptox.epa.gov/dashboard/chemical_lists/pfasmaster.
16. Winchell, L. J. et al. Per- and polyfluoroalkyl substances thermal destruction at water resource recovery facilities: A state of the science review. Water Environment Research (2020).
17. Tamjidi, S. & Ameri, A. A review of the application of sea material shells as low cost and effective bio-adsorbent for removal of heavy metals from wastewater. Environ Sci Pollut Res Int 27, 31105-31119, doi:10.1007/s11356-020-09655-7 (2020).
18. Hasanpour, M. & Hatami, M. Application of three dimensional porous aerogels as adsorbent for removal of heavy metal ions from water/wastewater: A review study. Adv Colloid Interface Sci 284, 102247, doi:10.1016/j.cis.2020.102247 (2020).
19. Mudhoo, A., Ramasamy, D. L., Bhatnagar, A., Usman, M. & Sillanpaa, M. An analysis of the versatility and effectiveness of composts for sequestering heavy metal ions, dyes and xenobiotics from soils and aqueous milieus. Ecotoxicol Environ Saf 197, 110587, doi:10.1016/j.ecoenv.2020.110587 (2020).
20. Tshikovhi, A., Mishra, S. B. & Mishra, A. K. Nanocellulose-based composites for the removal of contaminants from wastewater. Int J Biol Macromol 152, 616-632, doi:10.1016/j.ijbiomac.2020.02.221 (2020).
21. Kumar, S. R. & Gopinath, P. in Handbook of Advanced Industrial and Hazardous Wastes Management 27-48 (CRC Press, 2017).
22. Pi, Y. et al. Adsorptive and photocatalytic removal of Persistent Organic Pollutants (POPs) in water by metal-organic frameworks (MOFs). Chemical Engineering Journal 337, 351-371 (2018).
23. Ngwabebhoh, F. A. & Yildiz, U. Nature-derived fibrous nanomaterial toward biomedicine and environmental remediation: Today's state and future prospects. Journal of Applied Polymer Science 136, 47878 (2019).
24. Harms, H., Schlosser, D. & Wick, L. Y. Untapped potential: exploiting fungi in bioremediation of hazardous chemicals. Nat Rev Microbiol 9, 177-192, doi:10.1038/nrmicro2519 (2011).
25. Mir-Tutusaus, J. A., Baccar, R., Caminal, G. & Sarra, M. Can white-rot fungi be a real wastewater treatment alternative for organic micropollutants removal? A review. Water Res 138, 137-151, doi:10.1016/j.watres.2018.02.056 (2018).
26. Sun, S. et al. Genomic and molecular mechanisms for efficient biodegradation of aromatic dye. J Hazard Mater 302, 286-295, doi:10.1016/j.jhazmat.2015.09.071 (2016).
27. Sun, S. et al. Enhancement of Environmental Hazard Degradation in the Presence of Lignin: a Proteomics Study. Sci Rep 7, 11356, doi:10.1038/s41598-017-10132-4 (2017).
28. Chen, Z., Lv, Z., Sun, Y., Chi, Z. & Qing, G. Recent advancements in polyethyleneimine-based materials and their biomedical, biotechnology, and biomaterial applications. Journal of Materials Chemistry B 8, 2951-2973 (2020).
29. Zong, E. et al. A lignin-based nano-adsorbent for superfast and highly selective removal of phosphate. Journal of Materials Chemistry A 6, 9971-9983 (2018).
30. Mahapatra, C. T. et al. Comparative in vitro toxicity assessment of perfluorinated carboxylic acids. Journal of Applied Toxicology 37, 699-708 (2017).
31. Fujisawa, S., Saito, T., Kimura, S., Iwata, T. & Isogai, A. Surface engineering of ultrafine cellulose nanofibrils toward polymer nanocomposite materials. Biomacromolecules 14, 1541-1546 (2013).
32. Vo, H. N. P. et al. Poly- and perfluoroalkyl substances in water and wastewater: a comprehensive review from sources to remediation. Journal of Water Process Engineering 36, 101393 (2020).
33. Lu, D., Sha, S., Luo, J., Huang, Z. & Jackie, X. Z. Treatment train approaches for the remediation of per- and polyfluoroalkyl substances (PFAS): A critical review. Journal of hazardous materials 386, 121963 (2020).
34. Novotný, Č. et al. Irpex lacteus, a white rot fungus applicable to water and soil bioremediation. Applied Microbiology Biotechnology 54, 850-853 (2000).
35. Ross, R. J. Wood handbook: wood as an engineering material. USDA Forest Service, Forest Products Laboratory, General Technical Report FPL-GTR-190, 2010: 509 p. 1 v. 190 (2010).
36. Ververis, C., Georghiou, K., Christodoulakis, N., Santas, P. & Santas, R. Fiber dimensions, lignin and cellulose content of various plant materials and their suitability for paper production. Industrial crops and products 19, 245-254 (2004).
37. Palazzolo, S. et al. Early Warnings by Liver Organoids on Short- and Long-Chain PFAS Toxicity. Toxics 10, 91 (2022).
38. Li, Z. et al. Engineering cytochrome P450 enzyme systems for biomedical and biotechnological applications. Journal of Biological Chemistry 295, 833-849 (2020).
39. Wang, N., Buck, R. C., Szostek, B., Sulecki, L. M. & Wolstenholme, B. W. 5: 3 Polyfluorinated acid aerobic biotransformation in activated sludge via novel “one-carbon removal pathways”. Chemosphere 87, 527-534 (2012).
40. Yu, Y. et al. Microbial Cleavage of C—F Bonds in Two C6 Per- and Polyfluorinated Compounds via Reductive Defluorination. Environmental science & technology 54, 14393-14402 (2020).
41. Horst, J. et al. Water treatment technologies for PFAS: the next generation. 38, 13-23 (2018).
42. Liu, L. et al. Removal of perfluorooctanoic acid (PFOA) and perfluorooctane sulfonate (PFOS) from water by carbonaceous nanomaterials: A review. Critical Reviews in Environmental Science and Technology 50, 2379-2414 (2020).
43. Zhang, D., Zhang, W. & Liang, Y. Adsorption of perfluoroalkyl and polyfluoroalkyl substances (PFASs) from aqueous solution-A review. Science of The Total Environment 694, 133606 (2019).
44. Foote, M. A. Comparative Analysis of Treatment Technologies for PFAS in Water. (2020).
45. Garcia, A. N., Viciano, N. & Font, R. Products obtained in the fuel-rich combustion of PTFE at high temperature. Journal of analytical and applied pyrolysis 80, 85-91 (2007).
46. Yu, H. et al. Fungal treatment of cornstalks enhances the delignification and xylan loss during mild alkaline pretreatment and enzymatic digestibility of glucan. J Bioresource Technology 101, 6728-6734 (2010).
47. Peng, Y.-P., Chen, K.-F., Lin, W.-H., Chang, Y.-C. & Wu, F. A novel three-stage treatment train for the remediation of trichloroethylene-contaminated groundwater. RSC Advances 6, 41247-41260, doi:10.1039/C6RA04660F (2016).
48. Li, J., Yan, Q. & Cai, Z. Fabrication and characterization of emulsified and freeze-dried epoxy/cellulose nanofibril nanocomposite foam. Cellulose 26, 1769-1780 (2019).
49. Li, J., Wei, L., Leng, W., Hunt, J. F. & Cai, Z. Fabrication and characterization of cellulose nanofibrils/epoxy nanocomposite foam. Journal of materials science 53, 4949-4960 (2018).
50. Espinosa, E. et al. Suitability of wheat straw semichemical pulp for the fabrication of lignocellulosic nanofibres and their application to papermaking slurries. Cellulose 23, 837-852 (2016).
51. Chourey, K. et al. Direct Cellular Lysis/Protein Extraction Protocol for Soil Metaproteomics. Journal of Proteome Research 9, 6615-6622, doi:10.1021/pr100787q (2010).
52. Washburn, M. P., Wolters, D. & Yates, J. R., 3rd. Large-scale analysis of the yeast proteome by multidimensional protein identification technology. Nat. Biotechnol. 19, 242-247 (2001).
53. Hage, H. et al. Gene family expansions and transcriptome signatures uncover fungal adaptations to wood decay. Environmental Microbiology (2021).
54. Xu, T. et al. ProLuCID: An improved SEQUEST-like algorithm with enhanced sensitivity and specificity. J. Proteomics, doi:http://dx.doi.org/10.1016/j.jprot.2015.07.001.
55. Kall, L., Canterbury, J. D., Weston, J., Noble, W. S. & MacCoss, M. J. Semi-supervised learning for peptide identification from shotgun proteomics datasets. Nature methods 4, 923-925 (2007).
56. McIlwain, S. et al. Crux: rapid open source protein tandem mass spectrometry analysis. Journal of proteome research 13, 4488-4491 (2014).
57. Zhang, X. et al. Proteome-wide identification of ubiquitin interactions using UbIA-MS. Nature protocols 13, 530 (2018).
58. Shannon, P. et al. Cytoscape: a software environment for integrated models of biomolecular interaction networks. Genome research 13, 2498-2504 (2003).
59. Maere, S., Heymans, K. & Kuiper, M. BiNGO: a Cytoscape plugin to assess overrepresentation of gene ontology categories in biological networks. Bioinformatics 21, 3448-3449 (2005).
61. Guelfo, J. L. & Adamson, D. T. Evaluation of a national data set for insights into sources, composition, and concentrations of per- and polyfluoroalkyl substances (PFASs) in US drinking water. Environmental Pollution 236, 505-513 (2018).
62. Du, Z. et al. Removal of perfluorinated carboxylates from washing wastewater of perfluorooctanesulfonyl fluoride using activated carbons and resins. Journal of hazardous materials 286, 136-143 (2015).
63. Zhang, Q., Deng, S., Yu, G. & Huang, J. Removal of perfluorooctane sulfonate from aqueous solution by crosslinked chitosan beads: sorption kinetics and uptake mechanism. Bioresource technology 102, 2265-2271 (2011).
64. Yu, J., Hu, J., Tanaka, S. & Fujii, S. Perfluorooctane sulfonate (PFOS) and perfluorooctanoic acid (PFOA) in sewage treatment plants. Water research 43, 2399-2408 (2009).
65. Deng, S., Yu, Q., Huang, J. & Yu, G. Removal of perfluorooctane sulfonate from wastewater by anion exchange resins: Effects of resin properties and solution chemistry. Water Research 44, 5188-5195 (2010).
66. Moreno Ruiz, E. et al. Documentation of changes implemented in ecoinvent database v3. 7 & v3. 7.1. ecoinvent Association. Zürich, Switzerland (2020).
67. Deng, S. et al. Adsorption of perfluorinated compounds on aminated rice husk prepared by atom transfer radical polymerization. Chemosphere 91, 124-130 (2013).
68. Li, M., Yu, Z., Liu, Q., Sun, L. & Huang, W. Photocatalytic decomposition of perfluorooctanoic acid by noble metallic nanoparticles modified TiO2. Chemical Engineering Journal 286, 232-238 (2016).
69. Li, X. et al. Adsorption of ionizable organic contaminants on multi-walled carbon nanotubes with different oxygen contents. Journal of hazardous materials 186, 407-415 (2011).
70. Niu, Z. et al. Electrochemically enhanced removal of perfluorinated compounds (PFCs) from aqueous solution by CNTs-graphene composite electrode. Chemical Engineering Journal 328, 228-235 (2017).
71. Deng, S. et al. Enhanced adsorption of perfluorooctane sulfonate and perfluorooctanoate by bamboo-derived granular activated carbon. Journal of hazardous materials 282, 150-157 (2015).
72. Punyapalakul, P., Suksomboon, K., Prarat, P. & Khaodhiar, S. Effects of surface functional groups and porous structures on adsorption and recovery of perfluorinated compounds by inorganic porous silicas. Separation Science and Technology 48, 775-788 (2013).
73. Yan, T., Chen, H., Jiang, F. & Wang, X. Adsorption of perfluorooctane sulfonate and perfluorooctanoic acid on magnetic mesoporous carbon nitride. Journal of Chemical & Engineering Data 59, 508-515 (2014).
74. Yan, T., Chen, H., Wang, X. & Jiang, F. Adsorption of perfluorooctane sulfonate (PFOS) on mesoporous carbon nitride. RSC advances 3, 22480-22489 (2013).
75. Yu, Q., Zhang, R., Deng, S., Huang, J. & Yu, G. Sorption of perfluorooctane sulfonate and perfluorooctanoate on activated carbons and resin: kinetic and isotherm study. Water research 43, 1150-1158 (2009).
76. Liu, K. et al. Understanding the adsorption of PFOA on MIL-101 (Cr)-based anionic-exchange metal-organic frameworks: comparing DFT calculations with aqueous sorption experiments. Environmental science & technology 49, 8657-8665 (2015).
77. Karoyo, A. H. & Wilson, L. D. Tunable macromolecular-based materials for the adsorption of perfluorooctanoic and octanoic acid anions. Journal of colloid and interface science 402, 196-203 (2013).
78. Deng, S. et al. Highly efficient sorption of perfluorooctane sulfonate and perfluorooctanoate on a quaternized cotton prepared by atom transfer radical polymerization. Chemical engineering journal 193, 154-160 (2012).
79. Yu, Q., Deng, S. & Yu, G. Selective removal of perfluorooctane sulfonate from aqueous solution using chitosan-based molecularly imprinted polymer adsorbents. Water Research 42, 3089-3097 (2008).
80. Prosapio, V., Norton, I. & De Marco, I. Optimization of freeze-drying using a Life Cycle Assessment approach. (2017).

1-32. (canceled)

33. A method of making a renewable artificial plant for in-situ microbial environmental remediation (RAPIMER) comprising:
a) oxidizing lignocellulosic material to form cellulose microfibers;
b) optionally, washing said cellulose microfibers;
c) processing said cellulose microfibers in a homogenizer to form a cellulose nanofibril suspension;
d) recovering said cellulose nanofibril suspension;
e) providing dried lignin that has been modified with polyethylenimine and mixing said dried modified lignin with said recovered cellulose nanofibril suspension (solution);
f) cooling said lignin/cellulose nanofibril solution and freezing said lignin/cellulose nanofibril solution; and
g) freeze drying said lignin/cellulose nanofibril solution to form a RAPIMER and curing said RAPIMER.

34. The method according to claim 33, wherein said cellulose microfibers are washed in water prior to step b).

35. The method according to claim 34, wherein said cellulose microfibers are washed until the pH of said cellulose microfibers is neutral, for example, pH=7.00±0.1 or pH=7.00±0.05.

36. The method according to claim 33, wherein said oxidizing step comprises oxidation of said lignocellulosic material with (2,2,6,6-Tetramethylpiperidin-1-yl) oxyl (TEMPO), sodium bromide (NaBr), and sodium hypochlorite (NaClO).

37. The method according to claim 33, wherein said dried modified lignin and said recovered cellulose nanofibril suspension are mixed at a ratio of about 1:5 to about 5:1 cellulose nanofibril: modified lignin w/w, about 1:4 to about 4:1 cellulose nanofibril: modified lignin w/w, about 1:3 to about 3:1 cellulose nanofibril: modified lignin w/w, about 1:2 to about 2:1 cellulose nanofibril: modified lignin w/w, about 1:1 cellulose nanofibril: modified lignin w/w, or about 0.5:1 to about 1:0.5 cellulose nanofibril: modified lignin w/w, preferably about 1:1 cellulose nanofibril: modified lignin w/w.

38. The method according to claim 33, wherein said RAPIMER is cured at a temperature of about 50° C. to about 100° C., about 60° C. to about 90° C., 70° C. to about 80° C., or about 80° C.

39. The method according to claim 33, said lignin/cellulose nanofibril solution is frozen at a temperature of about −50° C. to about −100° C.

40. The method according to claim 33, said lignin/cellulose nanofibril solution is frozen at a temperature of about −60° C. to about −90° C., −70° C. to about −80° C., or about −80° C.

41. The method according to claim 33, said method further comprising applying one or more microorganisms to said RAPIMER, said microorganisms degrading one or more contaminant.

42. The method according to claim 41, wherein said one or more microorganism are bacterial and/or fungal and are a microorganism selected from Pseudomonas species (such as Pseudomonas vesicularis, Pseudomonas putida and Aeromonas hydrophila, Brevibacterium acetylicum), Nitrobacter species (such as Nitrobacter winogradskyi), Nitrosomonas species (such as Nitrosomonas europaea) Thiobacillus species (such as Thiobacillus denitrificans), white rot fungus, brown rot fungus, soft rot fungus, Acanthophysium spp., Aleurocystidiellum spp., Aleurodiscus spp., Athelia spp., Basidioradulum spp., Butlerelfia spp., Christiansenia spp., Corticium spp., Cystostereum spp., Cytidia spp., Dendrophora spp., Dentocorticium spp., Duportella spp., Entomocorticium spp., Hyphoderma spp., Hyphodontia spp., Peniophora spp., Phanerochaete spp., Phlebia spp., Pulcherricium spp., Resinicium spp., Vuilleminia spp., mitosporic Corticiaceae spp. (including Fibularhizoctonia Fibularhizoctonia), Anomoporia spp., Antrodia spp., Antrodiella spp., Aurantiporus spp., Auriporia spp., Bjerkandera spp., Ceriporia spp., Ceriporiopsis spp., Cerrena spp., Coriolopsis spp., Coriolus spp., Cryptoporus spp., Daedalea spp., Daedaleopsis spp., Datronia spp., Diplomitoporus spp., Donkioporia spp., Fomes spp., Fomitopsis spp., Gelatoporia spp., Hapalopilus spp., Laetiporus spp., Leptoporus spp., Megasporoporia spp., Melanoporia spp., Meripilus spp., Nigroporus spp., Nothopanus spp., Oligoporus spp., Ossicaulis spp., Oxyporus spp., Perenniporia spp., Piptoporus spp., Poria spp., Postia spp., Rigidoporus spp., Tinctoporellus spp., Trametes spp., Trichaptum spp., Tyriomyces spp., Wolfiporia spp., Byssomerulius spp., Ceriporia spp., Efibula spp., Emmia spp., Flavodon spp., Gloeoporus spp., Hydnopolyporus spp., Irpex spp., Leptoporus spp., Meruliopsis spp., and Trametopsis spp., Agaricus spp., Laetiporus and Sparassis spp., Irpex lacteus and combinations thereof, particularly Irpex lacteus alone or in combination with other microorganisms.

43. A RAPIMER produced by the method according to claim 33, said RAPIMER comprising lignin modified with polyethylenimine.

44. A RAPIMER comprising cellulose nanofibrils and lignin modified with polyethylenimine, wherein the carboxylic acid groups of the cellulose nanofibrils and amine groups found on the polyethylenimine modified lignin of the RAPIMER forming a carboxylic acid/amine salt, said RAPIMER being colonized or uncolonized.

45. The RAPIMER according to claim 44, said RAPIMER being a colonized RAPIMER colonized with a microorganism, for example a microorganism selected from Pseudomonas species (such as Pseudomonas vesicularis, Pseudomonas putida and Aeromonas hydrophila, Brevibacterium acetylicum), Nitrobacter species (such as Nitrobacter winogradskyi), Nitrosomonas species (such as Nitrosomonas europaea) Thiobacillus species (such as Thiobacillus denitrificans), white rot fungus, brown rot fungus, soft rot fungus, Acanthophysium spp., Agrocybe spp., Aleurocystidiellum spp., Aleurodiscus spp., Athelia spp., Armillaria spp., Basidioradulum spp., Botryobasidium spp., Butlerelfia spp., Christiansenia spp., Corticium spp., Crepidotus spp., Cystostereum spp., Cytidia spp., Dacrymyces spp., Dichomitus spp., Dendrophora spp., Dentocorticium spp., Duportella spp., Entomocorticium spp., Hypochnicium spp., Hypsizygus spp., Hyphoderma spp., Hyphodontia spp., Peniophora spp., Phanerochaete spp., Phlebia spp., Phlebiopsis spp., Platygloea spp., Pleurotus spp., Polyporus spp., Porodaedalea spp., Pulcherricium spp., Resinicium spp., Vuilleminia spp., mitosporic Corticiaceae spp. (including Fibularhizoctonia Fibularhizoctonia), Anomoporia spp., Antrodia spp., Antrodiella spp., Aurantiporus spp., Auriporia spp., Bjerkandera spp., Ceriporia spp., Ceriporiopsis spp., Cerrena spp., Climacodon spp., Coniochaeta spp., Coriolopsis spp., Coriolus spp., Cryptoporus spp., Daedalea spp., Daedaleopsis spp., Datronia spp., Diplomitoporus spp., Donkioporia spp., Echinodontium spp., Entoloma spp., Exidia spp., Fibroporia spp., Fomes spp., Fomitopsis spp., Fulvifomes spp., Fuscoporia spp., Ganoderma spp., Gelatoporia spp., Hapalopilus spp., Inonotus spp., Jaapia spp., Kneiffiella spp., Lentinula spp., Lentinus spp., Laetiporus spp., Leptoporus spp., Megasporoporia spp., Melanoporia spp., Meripilus spp., Nigroporus spp., Nothopanus spp., Oligoporus spp., Ossicaulis spp., Oxyporus spp., Peniophorella spp., Perenniporia spp., Phellinus spp., Piptoporus spp., Poria spp., Postia spp., Ramaria spp., Rigidoporus spp., Schizophyllum spp., Schizopora spp., Serpula spp., Sistotrema spp., Steccherinum spp., Stereum spp., Tapinella spp., Tinctoporellus spp., Tomentella spp., Trametes spp., Trichaptum spp., Tyriomyces spp., Wolfiporia spp., Byssomerulius spp., Ceriporia spp., Efibula spp., Emmia spp., Flavodon spp., Gloeoporus spp., Gloeophyllum spp., Hydnopolyporus spp., Hydnochaete spp., Irpex spp., Leptoporus spp., Meruliopsis spp., and Trametopsis spp., Trechispora spp., Tremella spp., Xylodon spp., Agaricus spp., Laetiporus and Sparassis spp., Irpex lacteus and combinations thereof, particularly Irpex lacteus alone or in combination with other microorganisms.

46. The RAPIMER according to claim 45, wherein said microorganism is Irpex lacteus alone or in combination with other microorganisms.

47. The RAPIMER according to claim 43, said RAPIMER exhibiting a Fourier Transform Infrared Spectroscopy (FTIR) spectra comprising the following characteristics: an amine peak at about 3380 cm⁻¹, C—H stretching and scissoring bands at 2940-2830 cm⁻¹ and 1463 cm⁻¹, and amide I and amide II with O═C stretch peaks around 1656 cm⁻¹ and 1599 cm⁻¹.

48. A filter apparatus comprising a housing that is non-permeable to a fluid, said housing comprising a proximal end, a distal end, a lumen containing a RAPIMER according to claim 44, said lumen being disposed between the proximal and distal end of said housing, a fluid sample inlet and a fluid sample outlet that create a flow-path through the lumen of the filter apparatus.

49. A method of decontaminating a sample comprising contacting a sample comprising at least one contaminant with a RAPIMER according claim 44, said at least one contaminant being selected from the group consisting of PFAS, an anionic dye molecule, chromium (Cr), cadmium (Cd), copper (Cu), and lead (Pb), perfluorooctane sulfonate (PFOS); perfluorooctanoic acid (PFOA); perfluorohexane sulfonate (PFHxS); poly fluorinated carboxylic acids, alkyl sulfonates; alkyl sulfonamido compounds; fluorotelemeric compounds; and combinations thereof.

50. A method of decontaminating a sample comprising contacting a sample comprising at least one contaminant with a RAPIMER according claim 43, said at least one contaminant being selected from the group consisting of PFAS, an anionic dye molecule, chromium (Cr), cadmium (Cd), copper (Cu), and lead (Pb), perfluorooctane sulfonate (PFOS); perfluorooctanoic acid (PFOA); perfluorohexane sulfonate (PFHxS); poly fluorinated carboxylic acids, alkyl sulfonates; alkyl sulfonamido compounds; fluorotelemeric compounds; and combinations thereof.
